(19) United States
(12) Patent Application Publication
(10) Pub. No.: US 2006/0029433 A1
(43) Pub. Date: Feb. 9, 2006

(54) Toner and toner cartridge

(76) Inventors: Takuya Saito, Numadu-shi (JP); Koichi Sakata, Numadu-shi (JP); Tomoyuki Ichikawa, Kanagawa-ken (JP); Shinya Nakaya, Numadu-shi (JP); Hisashi Nakajima, Numadu-shi (JP); Sonoh Matsuoka, Numadu-shi (JP); Akihiro Kotsugai, Nudamu-shi (JP); Yasuo Asahina, Numadu-shi (JP); Fumihiro Sasaki, Fuji-shi (JP); Satoshi Mochizuki, Numadu-shi (JP); Osamu Uchinokura, Mishima-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/192,051

(22) Filed: Jul. 29, 2005

(30) Foreign Application Priority Data
Jul. 29, 2004 (JP) 2004-222460

(51) Int. Cl. G03G 15/08

(52) U.S. Cl. 399/258

(57) ABSTRACT

A toner for an image forming apparatus having a volume average diameter of from 2 to 8 μm is manufactured by reacting an aqueous dispersion comprising at least one pigment, a polymer and/or a mixture of monomers to form fine toner particles wherein the amount of fine particles having a diameter of one-half the average number diameter are present in an amount of 20% by number or less, a toner cartridge containing the toner and a method for using the toner.

### BACKGROUND OF THE INVENTION

1. Field of the Invention

The present invention relates to a toner useful for forming an image with an electrophotographic copying machine, toner cartridge containing the toner, and image forming apparatus using the toner.

2. Description of the Related Art

In the image forming apparatus for the electrophotography, a toner image is formed on the photoconductor through the steps comprising charging the surface of the photoconductor which is a carrier of the image by the discharge, exposing the surface of the charged photoconductor for forming a latent electrostatic image on the surface of the photoconductor and developing the latent electrostatic image formed on the surface of the photoconductor by supplying a toner having a polarity which is reverse to the polarity of the latent static image formed on the surface of the photoconductor to the latent static image.

The toner image formed on the photoconductor is either transferred to a recording member, such as a paper from the intermediate transferring medium, or through transferring the toner image from the photoconductor directly to the recording medium, fixed on the recording medium by applying heat and pressure to the transferred toner image on the recording medium.

Recently is has become more important that the image formed from electrophotographic processes are of high quality and precision. The size of the toner particles such as the diameter of the toner particles may be an important determinant of image quality. Smaller particle size (e.g., grain size) for the toner may cause some disadvantages such as lowered toner fluidity. Small particle sized toners may also have a tendency to adhere to s=conveying screws and thereby cause problems such as jamming in toner feed cartridges. In order to achieve high copying and/or image forming speed it is necessary to be able to reliably supply large amounts of toner quickly and without surging. Thus larger toner feed cartridges are sometime used to ensure an adequate supply of toner.

The use of a toner receipt container receptacle that is located separately from a developing device may permit the use of a smaller image forming device. An agent transfer apparatus using a powder pump is connected to the developing device and separated from the toner receipt container receptacle. Thus a toner may be supplied smoothly between the toner receipt container receptacle and any developing or image forming apparatus.

Japanese laid open 2004-037911 discloses image forming device as follows. Image forming device which air supply passage from air outlet of an air feed means to junction part with toner refilling road is placed at bearing height position more upward than gravity direction last place in the ranking position of toner refilling road.

In addition, for example, in Japanese Patent Laid-Open No. 2002-087592, powder shifting pump which have stator which have through-hole was formed and the rotor which was placed at the through-hole. By a revolution of the turbine rotor, powder is transferred from the inlet opening side of the through-hole to the outlet openings side.

The powder shifting pump which provided powder drained from outlet openings of the through-hole with agitation means to give agitation effect.

Conventional small particle size toners have a tendency to pack and bridge inside a screw feeding apparatus. The packing may be due to forces including compression of the toner particles and/or heat caused, for example, by friction in the delivery screw, which causes a packing effect of the toner. Thus the toner may bridge across and around the screw thereby causing surging during feeding.

Because of these reasons, a need exists for a transfer means or device for smoothly moving a small grain diameter toner from, for example, a toner receipt container receptacle to an image forming device or apparatus. However, by the above disclosed technics, smooth feeding of toner to a developing apparatus is difficult, especially for toners having small grain diameter.

### SUMMARY OF THE INVENTION

Accordingly, one object of the present invention is to provide a toner having high fluidity, an image forming device capable of toner refilling smoothly by means of the powder convey apparatus for even small diameter toners using a powder pump. In another embodiment an object of the invention is a most suitable toner to apply to the image forming device and the toner container for receiving the toner.

### BRIEF DESCRIPTION OF THE DRAWINGS

Various other objects, features and attendant advantages of the present invention will be more fully appreciated as the same becomes better understood from the detailed description when considered in connection with the accompanying drawing(s) in which like reference characters designate like corresponding parts throughout and wherein:

FIG. 1 shows an embodiment of the image forming device of the present invention;

FIG. 2 shows a process cartridge that may be used in the image forming device of FIG. 1;

FIG. 3 shows the amorphous silicon photoconductor structure that may be present in one embodiment of the image forming device of the invention;

FIG. 4 is a diagramatic chart which shows improved voltage and concern of electro static charge potential of photo conductor;

FIG. 5 is a schematic view illustrating an embodiment of a contact charger for the image forming apparatus of the present invention;

FIG. 6 shows a fixing apparatus of one embodiment of the invention that may be used in the image forming apparatus and/or with the toner of the invention;

FIG. 7 is block diagram which shows schematic frame work of powder convey apparatus;

FIG. 8 is a schematic diagram which shows architecture of powder convey apparatus;

FIG. 9 is a schematic view of powder convey apparatus of other embodiments;

FIG. 10 is a time chart which shows timing of ON and OFF of each part at the time of the described above toner refilling;

FIG. 11 shows a drawing showing a toner receipt container (121) with the use of a flexible material; and

FIG. 12 shows a drawing showing shape typically of a toner concerning the present invention.

### DETAILED DESCRIPTION OF THE PREFERRED EMBODIMENTS

In one aspect the present invention provides a toner having a volume-average particle diameter (Dv) of from 2 to 8 μm, having 20% by number or less of toner particles having a number average diameter (Dn) of Dn/2 or below.

As compared to a comminution toner, a small diameter and manufacture of a small toner of a granular variation are easy for a polymerization method toner.

However even if treated, fine powder of polymerization method toner is easy to be become sphere. Spherical powders may have disadvantages and are not preferred in the invention toner. Spherical particles may have a tendency to agglomerate through the large number of interparticle contact.

Therefore when toner particle was stagnant for a long time in the same location, powder touches with plural toner particle. And intermolecular force is in a strong condition in fine powder being approximately sphere. As a result, fluidity falls in toners being strongly tied. In addition, when, in flexible receipt bag, a polymerization method toner is filled with flexible receipt bag, it become approximately closest packing statement. The invention toner may have good fluidity after formation. In contrast to conventional toners the toner of the present invention may have sufficient fluidity initially without changing. Because the invention toner has high fluidity initially it is not necessary to use a non-flexible toner receipt container that is agitated or revolved during feeding of the toner particles. Thus the invention toner particles are subjected to less disruption and are less likely to form fines which may change the fluidity of the toner.

In this present invention, Even if it is flexible receipt bag and capillary, There becomes little fine powder, and preferably it is the approximately same as circularity of average grain of a toner, and circularity of fine powder is done, and enough force is added between particles the adhesive force which there is between toners is reduced, and to understand a toner. By it, lowness of early stage of fluidity can be improved.

There is no restriction in particular to make the toner of the present invention. Toner manufacturing method to have a process dispersing a polymer or polymerization-related monomeric substance by the end of aqueous vehicular is desirable, and, by way of example only, it is suspension polymerization method and emulsification coagulation process.

In aqueous vehicular, toner manufacturing method to have a process scattering the organic solvent which a polymer or polymerization-related monomeric substance was incorporated into at least is more desirable.

By such a toner manufacturing method, In comparison with conventional grinding system, accuracy is preferable, and a small diameter and toner particle of particle size may be obtained.

But there is the time when such a toner manufacturing process occurs in much fine powder with toner particle of particle size aimed at. To remove fine powder from toner particle, there is an approach to remove fine powder by a wind force classifying machine. (Elbow jet classifier manufactured by Nittetsu Mining Co. Ltd.), Turbo Mill (manufactured by Turbo Kogyo Co., Ltd.). The presence of a large amount of fine particles may lead to changes in the invention toner's fluidity. Preferably, the invention toner contains a minimum amount of fine toner particles. In a further preferred embodiment of the invention fine toner particles are removed from the invention toner by, for example, gas force classification.

However, much energy is used by classifying. Besides, it is difficult to remove fine powders that are near the 2-8 μm particle diameter range of the invention toner. For example, separating and/or removing fine powder having a particle size of from 1 μm to slightly less than 2 μm is difficult. It becomes necessary to remove toner particle of particle size of an aim with fine powder, and yield is big, and it falls to remove fine powder of particle size of the limit. Therefore when preferably size enlargement does a particle in the whole aqueous vehicular, an appropriate amount uses emulsification stabilizer or surface-active agents such as fine inorganic particles or resin fine grain, and it is desirable that fine powder does granulation of the small granular variation which does not occur.

In one embodiment the toner of the invention has a Dᵥ of from 2 to 8 μm and the content of fine powder having a diameter of Dn/2 is present in an amount of 20 number % or less. In a further more preferable embodiment Dᵥ is from 3 to 7 μm and particles in the range of from 0.7 to 2.0 μm (as determined by a flow-type grading image analyzer) are present in an amount of 8 number % or less. In further embodiments the amount of fine particles are even less. For example, an amount of fine particles of Dn/4 is less than 10 number %. Further preferably, the amount of fine particles having a diameter of from 0.7 to 2.0 μm may be 7, 6, 5 or 4% or less.

As described above it is necessity that fine powder quantity of a toner has a Dv=2-8 μm and lower than content 20 several % of fine powder of less than or equal to Dn/2 at least. It is preferable that Dv is from 3 to 7 μm and particles 0.7-2.0 μm (measurement with a flow-type grading image analyzer device) are 8% or less.

Furthermore, when as described above a toner receipt container was set at a toner reservoir body of an image forming device, drive division of the main body of image forming device drives, and it is coupled with a powder pump.

The invention toner may provide advantages in image forming devices where a connection between the powder pump and a toner reservoir is movable. In one embodiment of the invention image forming device the powder pump is connected to the image forming apparatus through a connecting part. The connecting part which connects the powder pump to the image forming apparatus is movable. The toner of the invention is preferable in a moving connecting part because of its fluidity. The invention toner is easily able to be transferred from the powder pump to the image forming apparatus.

Present toner is desirable for use for the image forming device which drive division of the main body of image forming device drives, and a powder pump is coupled with and part of the member which touch subject that a toner or a developer can leave a movability by means of drive engaging of clutch.

When the member which can leave a movability by drive engaging of clutch and a toner or a developer touch, fine powder of the whole toner may get between flexible region.

Like a powder pump, reliability of drive division has a great influence on toner transportation in that case of the system which drive division drives because it is set a receipt container at an image forming device machine body in particular. The reason is because when a dependability of drive division declines the toner stops up and hardening of a toner can occur. As jamming occurs in the connecting part between the powder pump and the apparatus the blockage in the connector can create a sound that is audible to users of the image forming apparatus.

This is example for carrying out the invention is explained below based on drawing.

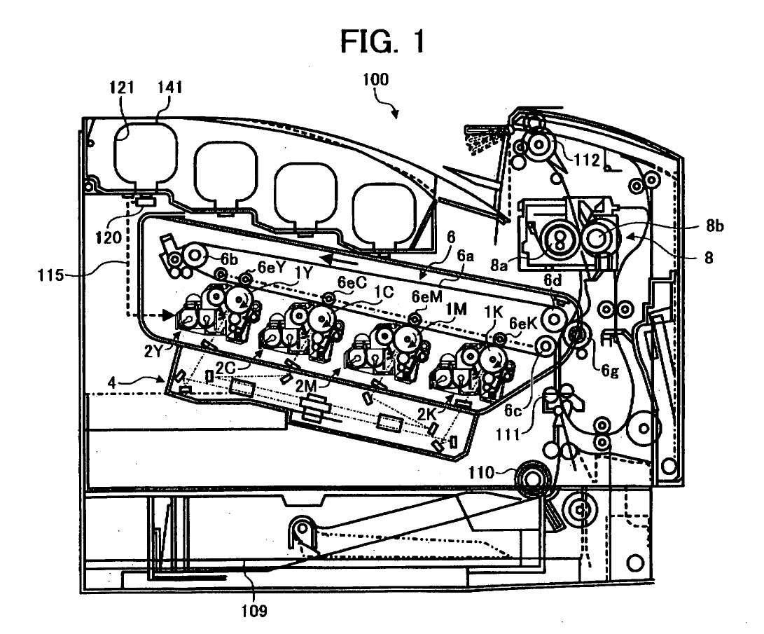

FIG. 1 is view which shows contour configuration of an image forming device of the present invention.

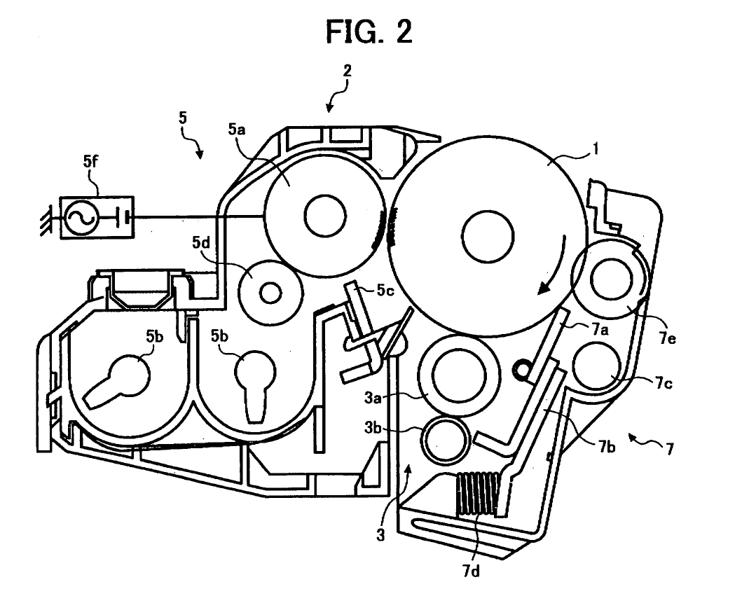

FIG. 2 is view which shows configuration of a process cartridge of an image forming device shown in FIG. 1.

Around photo conductor (1) which is image field to carry, contact charger (3), exposure equipment (4), development apparatus (5), a transfer point (6), a cleaning unit (7), fuser (8) are placed.

There is no particular limitation to the shape and material of an electroconductive support, so that the electroconductive support may be plate-shaped, drum-shaped or belt-shaped for example which made of Al. Example of a material of a photosensitive layer is amorphous selenium, photoconductivity with perylene pigments, a phthalocyanine organic compound, amorphous silicon. Amorphous silicon is particularly preferable. Amorphous silicon photo conductor having a photoconductive layer comprising a-Si can be used (“a-Si photo conductor” is made as follows).

After a substrate is heated by electroconductivity to 50 degrees Celsius-400 degrees Celsius, a layer is formed by a method such as vacuum evaporation method, sputtering method, ion plating method, thermal CVD method, photo-assisted CVD method, plasma CVD method. Above all, plasma CVD method namely a source gas is dismantled by means of a direct current or a radiofrequency wave or a microwave glow discharge, and an approach to form a-Si deposited film on substrate is preferred.

The optical writing device (4) emits four laser beams to the photoconductor for electro photography (1). An exemplary laser beam L according to image data corresponding to yellow color irradiates the photoconductor for electro photography (1) through a path formed between the charging device 3Y and the developing device 5Y, so that an electrostatic latent image is formed on the photoconductor for electro photography (1). As an alternative, the optical writing device (4) can adapt a LED method in place of the laser beam method.

The exposing unit 4 converts data that is read by a scanner in a reading unit 20 and an image signal transmitted from outside like from a PC, which is not shown in the diagram. The exposing unit 4 allows scanning a laser beam 3a by a polygon motor and forms an electrostatic latent image on the image carrier 1 based on the image signal that is read through a mirror.

The developing unit 5 includes developer sleeve (5a) which is a developer carrier that carries developer to the photo conductor 1, and a toner supplying chamber. The developing unit 5 further includes a cylindrical developer carrier that is disposed in a position such that the cylindrical developer maintains a minute gap with the photo conductor 1, and a developer regulator that regulates the amount of the developer on the developer carrier.

The developer carrier includes a hollow developer cylinder that is rotatably supported inside the developer carrier and a magnet roll that is fixed to the same shaft inside the hollow cylindrical developer carrier. The developer adheres magnetically on an outer peripheral surface of the developer carrier and is carried further.

The developer carrier is formed by a photoconductive and non-magnetic material. A power supply for applying developing bias is connected to the developer carrier. The power supply applies voltage between the developer carrier and the image carrier 1, thereby forming an electric field in an area of developing.

The developing apparatus may be used with a one component or two component developer. The toner of the invention may be used to form images of good quality with one or both of the one component and/or two component developer.

The transferring unit 6 includes a transfer belt 6a, a transfer bias roller 6b and a tension roller 6c. The transfer bias roller 6b includes a core of a metal like iron, aluminum, stainless etc. with an elastic layer (a layer of an elastic material) on a surface. To keep a paper in a close contact with the image carrier 1, a pressure necessary on a side of the image carrier 1 is applied on the transfer bias roller 6b. Effectiveness of the transfer belt 6a depends on a heat resistant material that is selected as a base material of the transfer belt 6a. The transfer belt 6a, for example, can be made of a seamless polyimide film. On an outer surface of the seamless polyimide film, a layer of fluorine-contained resin can be applied. Moreover, if it is necessary, a layer of silicone rubber may be applied on the polyimide film and a layer of fluorine-contained resin can also be applied. A tension roller is provided on an inner side of the transfer belt 6a to drive the transfer belt 6a and to apply tension in the transfer belt 6a.

The fixing unit 8 includes a fixing roller 8a having a heater for heating a halogen lamp and a pressurizing roller 8b that is in pressed contract. The fixing roller includes a core with an elastic layer (a layer of an elastic material) of 100 μm to 500 μm thickness, desirably of 400 μm thickness on it, and an outer layer of a resin having good mold releasing property like a fluorine-contained resin, to prevent adhesion of toner due to viscosity. The outer resin layer is formed by a PFA tube. Taking into consideration the mechanical deterioration, it is desirable that the thickness of the outer resin layer is in a range of 10 μm to 50 μm. A temperature detector is provided on an outer peripheral surface of the fixing roller and a heater is controlled to maintain almost a constant temperature of about 160° C. to 200° C. on the surface of the fixing roller. The pressurizing roller includes a core having an outer surface covered with a layer of an offset preventing material like tetrafluoroethylene-perfluoroalkyl vinyl ether (PFA) or polytetrafluoro ethylene (PTFE). A layer of an elastic material like silicone rubber may be applied on an outer surface of the core, similar to that in the fixing roller.

The fixing unit 8 includes a fixing roller 8a having a heater for heating a halogen lamp and a pressurizing roller 8b that is in pressed contract. The fixing roller includes a core with an elastic layer (a layer of an elastic material) of 100 μm to 500 μm thickness, desirably of 400 μm thickness on it, and an outer layer of a resin having good mold releasing property like a fluorine-contained resin, to prevent adhesion of toner due to viscosity. The outer resin layer is formed by a PFA tube. Taking into consideration the mechanical deterioration, it is desirable that the thickness of the outer resin layer is in a range of 10 μm to 50 μm. A temperature detector is provided on an outer peripheral surface of the fixing roller and a heater is controlled to maintain almost a constant temperature of about 160° C. to 200° C. on the surface of the fixing roller. The pressurizing roller includes a core having an outer surface covered with a layer of an offset preventing material like tetrafluoroethylene-perfluoroalkyl vinyl ether (PFA) or polytetrafluoro ethylene (PTFE). A layer of an elastic material like silicone rubber may be applied on an outer surface of the core, similar to that in the fixing roller.

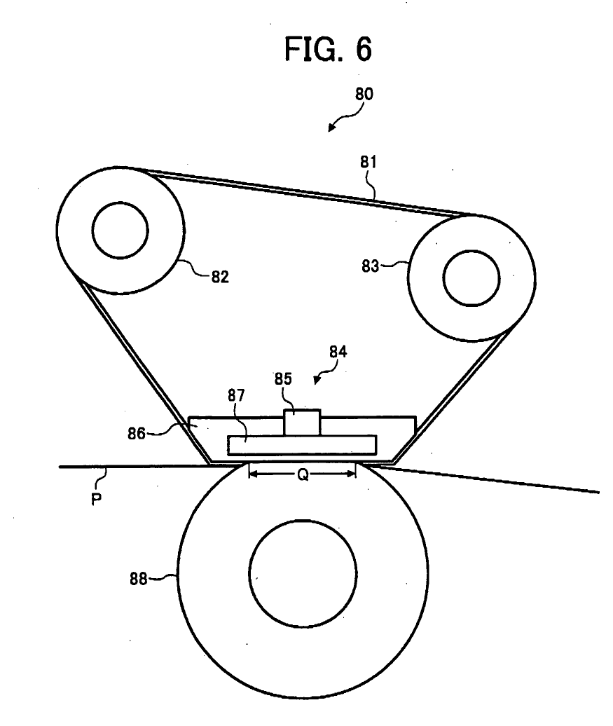

The fixer (8) is a surf fixer (80) rotating a fixing film as shown in FIG. 6. The fixing film (81) is a heat resistant film having the shape of an endless belt, which is suspended and strained among a driving roller, a driven roller and a heater located therebetween underneath.

The driven roller is a tension roller as well, and the fixing film rotates clockwise according to a clockwise rotation of the driving roller in FIG. 6. The rotational speed of the fixing film is equivalent to that of a transfer material at a fixing nip area Q where a pressure roller and the fixing film contact each other.

The pressure roller has a rubber elastic layer having good releasability such as silicone rubbers, and rotates counterclockwise while contacting the fixing nip area Q at a total pressure of from 4 to 10 kg.

The fixing film preferably has a good heat resistance, releasability and durability, and has a total thickness not greater than 100 &mgr;m, and preferably not greater than 40 μm. Specific examples of the fixing film include films formed of a single-layered or a multi-layered film of heat resistant resins such as polyimide, polyetherimide, polyethersulfide (PES) and a tetrafluoroethyleneperfluoroalkylvinyle the copolymer resin (PFA) having a thickness of 20 μm, on which (contacting an image) a release layer including a fluorocarbon resin such as a tetrafluoroethylene resin (PTFE) and a PFA and an electroconductive material and having a thickness of 10 μm or an elastic layer formed of a rubber such as a fluorocarbon rubber and a silicone rubber is coated.

As shown in FIG. 2, a cleaning unit (7) has a cleaning blade (7a) as cleaning means of a toner remaining in a photo conductor (1) face after a transferal process. In addition, a cleaning unit (7) includes a recovery coil (7c) transporting toner recovery blade (7e) collecting a cleaned toner and the toner. Furthermore, toner recovery black box (not illustrated) is included.

The first cleaning blade (7a) is made of a material like a metal, a resin, a rubber etc. and it is desirable to use fluorine contained rubber, silicone rubber, butyl rubber, butadiene rubber, isoprene rubber, and urethane rubber. Among these rubbers, the urethane rubber is particularly desirable.

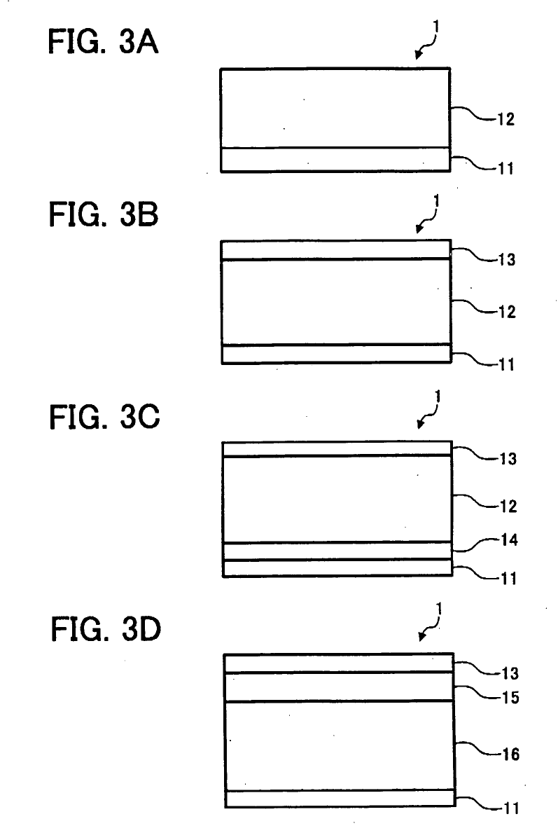

Examples of the layer structure of the amorphous silicon photoconductor are as follows. FIGS. 3A, 3B, 3C and 3D are schematic diagrams which explain the layer structure of the amorphous silicon photoconductor. With reference to FIG. 3A, a photoconductor for electrophotography (1) has a substrate (11) and a photoconductive layer (12) on the substrate (11). The photoconductive layer (12) is formed of a-Si:H and exhibits photoconductivity. With reference to FIG. 3B, a photoconductor for electrophotography (1) has a substrate (11), on which a photoconductive layer (12) formed of a-Si:H and an amorphous silicon surface layer (13) are arranged. With reference to FIG. 3C, a photoconductor for electrophotography (1) has a substrate (11), and on the substrate (11), a photoconductive layer (12) formed of a-Si:H an amorphous silicon surface layer (13) and an amorphous silicon charge injection inhibiting layer (14).

With reference to FIG. 3D, a photoconductor for electrophotography (1) has a substrate (11) and a photoconductive layer (12) on the substrate (11). The photoconductive layer (12) comprises a charge generation layer formed of a-Si:H (15) and a charge transport layer (16). The photoconductor for electrophotography (1) further has an amorphous silicon surface layer (13) on the photoconductive layer (12). Surface hardness of amorphous silicon system photo conductor is high. Amorphous silicon photo conductor shows high sensibility to long wavelength lights such as laserbeam (770-800 nm) of laser diode, besides, degradation by a repeat application is had few, too. That is why it is used as photo conductor (1) of image forming devices (100) such as high-speed duplicator or laser-beam printer (LBP).

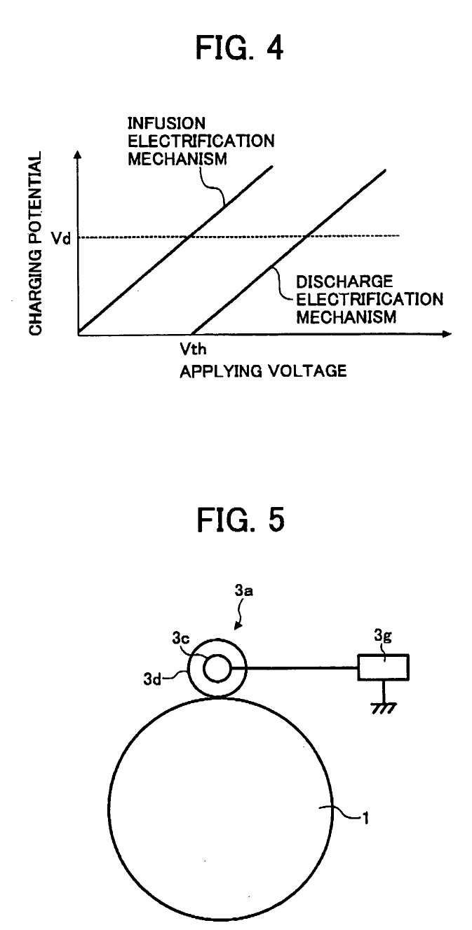

FIG. 4 is a diagramatic chart which shows the relationship between voltage and static charge potential of photo conductor. In injection electrification mechanism by a contact, photo conductor (1) can be charged with application of voltage. And impressed voltage can be lowered to make photo conductor (1) constant electro static charge potential Vd. Therefore, evolution of ozone can be reduced. At a threshold value Vth air is destroyed by Paschen's law in discharge electrification mechanism, and to discharge electricity. Therefore, a large applied potential is necessary to make photo conductor (1) constant potential Vd.

FIG. 5 is a schematic view illustrating an embodiment of a contact charger for the image forming apparatus of the present invention.

Contact charger (3) is charged with electricity equally in a face of photo conductor (1). Contact charger (3) in the present embodiment includes charging roller (3a) as the electro static charge member subject which processes electro static charge electrifying negative pole characteristics at so-called contact/appulse electro static charge mode.

It is preferable to use a charge roller (3a) toward contact with photo conductor (1).

As shown in FIG. 5, a roller-shaped charging roller as a charger contacting the photoreceptor is basically formed of a metallic shaft and an electroconductive rubber layer circumferentially and concentrically overlying the metallic shaft. Both ends of the metallic shaft are rotatably supported by a bearing (not shown), etc. and the charging roller is pressed against the photoreceptor by a pressurizer (not shown) at a predetermined pressure. In FIG. 5, the charging roller rotates according to the rotation of the photoconductor. The charging roller has a diameter of 16 mm because of being formed of a metallic shaft having a diameter of 9 mm and a middle-resistant rubber layer having a resistance of about 100,000 Ω·cm coated on the metallic shaft.

In addition, the charging roller (3a) may be cleaned by a cleaning roller (3b) to prevent what cause electro static charge defectiveness such as electro static charge unevenness by charging roller (3a) when a toner slightly bonded.

The charger for use in the present invention may have any shape including a roller, magnetic brushes, and fur brushes, and any shape besides a roller such as magnetic brushes and fur brushes, and is selectable according to a specification or a form of the electrophotographic image forming apparatus (100). The magnetic brush may be formed of various ferrite particles such as Zn—Cu ferrite as a charging member, a non-magnetic electroconductive sleeve supporting the charging member and a magnet roll included by the non-magnetic electroconductive sleeve. The fur brush is a charger formed of a shaft subjected to an electroconductive treatment and a fur subjected to an electroconductive treatment with, e.g., carbon, copper sulfide, metals and metal oxides winding around or adhering to the shaft.

In FIG. 6, the heater is formed of a flat substrate and a fixing heater (87), and the flat substrate is formed of a material having a high heat conductivity and a high electric resistance such as alumina. The fixing heater (87) formed of a resistance heater is located on a surface of the heater contacting the fixing film in the longitudinal direction of the heater. A electric resistant material such as Ag/Pd and Ta2N is linearly or zonally coated on the fixing heater (87) by a screen printing method, etc. Both ends of the fixing heater (87) have electrodes (not shown) and the resistant heater generates a heat when electricity passes though the electrodes. Further, a fixing temperature sensor formed of a thermistor is located on the other side of the substrate opposite to the side on which the fixing heater (87) is located.

Temperature information of the substrate detected by the fixing temperature sensor is transmitted to a controller controlling an electric energy provided to the fixing heater (87) to make the heater have a predetermined temperature.

By using fixing apparatus (80), image forming device (100) with fixer (8) is efficient and reduction of rising edge is enabled.

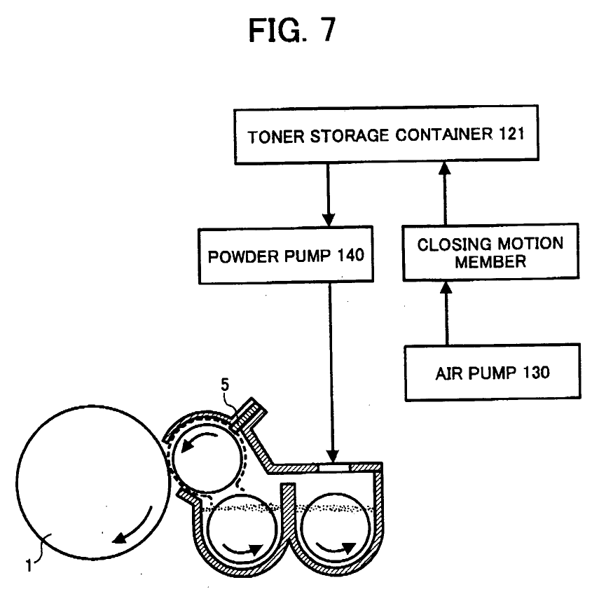

FIG. 7 is block diagram which shows schematic frame work of powder convey apparatus. Drive/control of powder convey apparatus (120) controls drive/control of a powder pump (140) and an action of an air pump (130) by a power source and the control circuit which are not illustrated.

The mechanism which control of powder convey apparatus (120) detects a toner based on a toner concentration sensor installed in one part of development apparatus (5) and a change of mixture ratio of carrier, and control a toner refilling amount is used. However, for example, know-hows reflection density of toner images in photo conductor (1) is detected as other mechanisms, and to control a toner refilling amount may be used. Powder convey apparatus (120) is controlled by the control equipment which comprising MPU which is not illustrated. In other words a detection result of a toner concentration sensor is taken in by MPU.

An actuating-signal is transmitted to powder pump drive source or a drive transmission means (clutch etc.), an air pump (130) depending on detection effect by MPU. By it, a toner refilling action to development apparatus takes place. MPU has a timer function and a drive motor, an air pump can be controlled operation of in arbitrary timing.

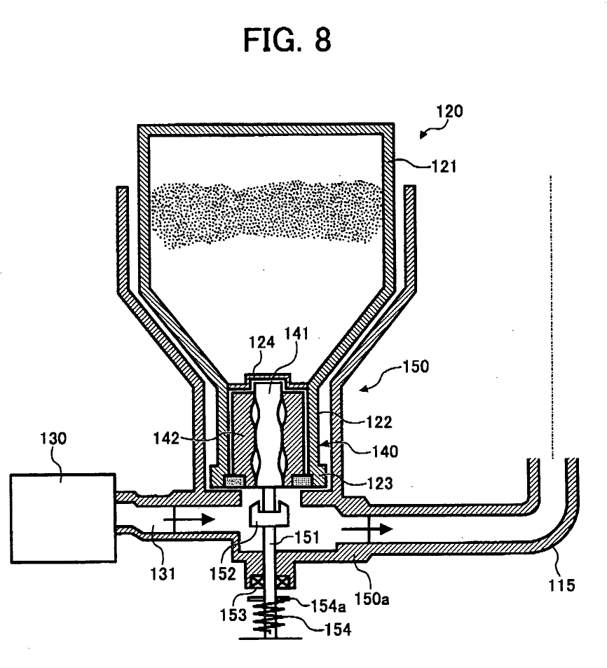

FIG. 8 is a schematic diagram which shows architecture of powder convey apparatus. The image forming device of the present invention has a toner powder convey apparatus (120) which a toner of a toner receipt container (121) goes through transfer tube (115) by pump force of a powder pump (140) in this development apparatus (5).

When toner refilling signal is transmitted, a turbine rotor (141) of a powder pump (140) and an air pump (130) operate at the same time for predetermined time. And fluidity toner is sent through transfer tube (115) to development apparatus (5) with a powder pump (140). As thus described toner transfer tube (115) can be prevented from being clogged up with toner when it is done. Because a remnant toner of transfer tube (115) can be drained only by means of air.

The tube 115 has a diameter of, e.g., 4 mm to 10 mm and should preferably be formed of a flexible material, e.g., polyurethane, nitril, EPDM, silicone or similar rubber highly resistant to toner, so that the tube 115 can be arranged in any desired direction.

When the inside diameter of the tube is less than 4 mm, it is inefficient of sending the amount of an enough toner.

When the inside diameter of the tube is larger than that of 10 mm. The control of the amount of the toner with high accuracy is difficult.

Developer in development apparatus (5) is transported by agitation transportation screw (56), and it is circulated. An electrostatic latent image which formed on photo conductor (1) developed by developer transferred to developing sleeve (5a) in the middle of transportation road (131) during this circulation. In addition, only air is missed by air filter which is present in the development apparatus (5) from transferred toner and the air. By it, a connecting device at the time of toner refilling and toner scattering from development apparatus (5) can be prevented. As for the toner receipt container (121), the lower part middle is opened in bag shape and mouthpiece member (122) made in polyethylene or nylon in an opening is fixed. For a toner receipt container, it is preferable to use a flexible toner receipt container (121) and preferred a form of bag container comprising monolayer or bilayer of flexible sheet (thickness of around 80-125 μm) such as polyester film, and a polyethylene film.

In addition, the toner receipt container (121) is not limited by this bag shape, a horizontal shape is also permitted, and it is preferable toner should be transported to a powder pump (140).

Mouthpiece member (122) is formed in the shape of sleeve, and the detachable powder pump (140) is located in hollow center. The powder pump 140, which is a single axis, eccentric screw pump, is generally made up of a screw-like rotor 141, a stator 142, and a holder 143. The rotor 141 is implemented as an eccentric screw formed of metal or similar rigid material. The stator 142 is formed of rubber or similar elastic material.

For this case, the stator (142) is fitted in mouthpiece member subject (122) from the lower part. And it is kept the position where it was provided with carrier member (123). In addition, carrier member (123) is removably fixed to mouthpiece member (122) by threads.

Therefore if this carrier member (123) is taken off, as shown in FIG. 8, stator (142) and a turbine rotor (141) can be attached and detached to from a toner receipt container (121).

In addition, stopper mouthpiece member (122), and a stopper (124) are present. This stopper (124) can prevent the turbine rotor (141) from entering the container by means of revolution. In addition, a stopper (124) may be provided with the axle box bearing that a revolution supports a turbine rotor (141) freely. Is rotationally driven by the drive source which a toner receipt container (121) installed in an image forming device machine body does not illustrate in set set part (150), spreading driving shaft (151) is installed in above or the below direction, driving shaft (151) goes through bearing (153) in the bottom part (150a) of set part (150), and is supported by spin liberty, and rotor (141) and engageable joint (152) are fixed at the head namely the upper end.

In addition, it is raisable or lowerable, and driving shaft (151) is loaded and it is biased to the upper part with a spring (154).

Thus, driving shaft (151) waits in the location that a clamp plate (154a) abuts with an axle box bearing (153) so that when toner receipt vessel (121) is set, in the location which fell down than the location which function of a spring (154) is resisted, and waited, joint (152) engages rotor (141), when the, engaging is certain by spring force.

It is form of pipe which the part that a toner is discharged with a powder pump (140) is left-and right-hand, and spread. One end of the pipe goes through transfer tube (115), and it is connected to development apparatus (5).

In addition, it is connected with another end of pipe through an air pump (130) as an air feed means and air pipe (131).

Thus, the toner drained from a container with a powder pump (140) is transferred to development apparatus (5) with the flow of air from air pump (130).

It is known that the single-shaft eccentric screw pump, such as powder pump 140, is capable of continuous constant-quantity delivery of powder at a high solid-gas ratio, so that an accurate quantity of a toner can be delivered proportional to the number of revolutions of the rotor 142. Accordingly, when a toner replenishing command is issued in response to, for example, detection of an image density, the powder pump 140 operates so as to replenish the developing apparatus 10 with a requested quantity of the toner. When rotor (141) rotates, a powder pump (140) occurs in delivery pressure in lower direction and occurs in aspiration pressure in upper direction.

This delivery pressure or size of an absorption pressure depends on rotor (141) of powder pump (140), number of revolutions of configuration and rotor (141) of stator (142) for. In addition, position of bearing height of transfer tube (115) and above or the below right and left can be transferred freely. Even more particularly, maximum stream flow (no load time) may have a low rate of feed of air, e.g., 1 or 2 liters/minute. An air vent in development apparatus (5) prevents toner outbreak easily.

A powder pump (140) installed in a toner receipt container (121) works in conjunction with an auto shut valve which completely seals at the time of stop. An aperture of a toner receipt container (121) may be sealed to prevent toner scattering outside. Therefore, toner dispersion at the time of interchange, contamination can be prevented.

Even more particularly, a powder pump (140) can attachable from a toner receipt container (121), and therefore reactivation can recycle a pump part. In addition, a powder pump (140) is not usable when stator (142) comprising rubber is worn. In this case if only stator (142) is changed, a turbine rotor (141) can be used again and again. Lower part of a toner receipt container (121) is geometry funnel-shaped towards toner discharge port. A toner in a container is drained without remaining behind in a container by force of gravity and upstream of a powder pump.

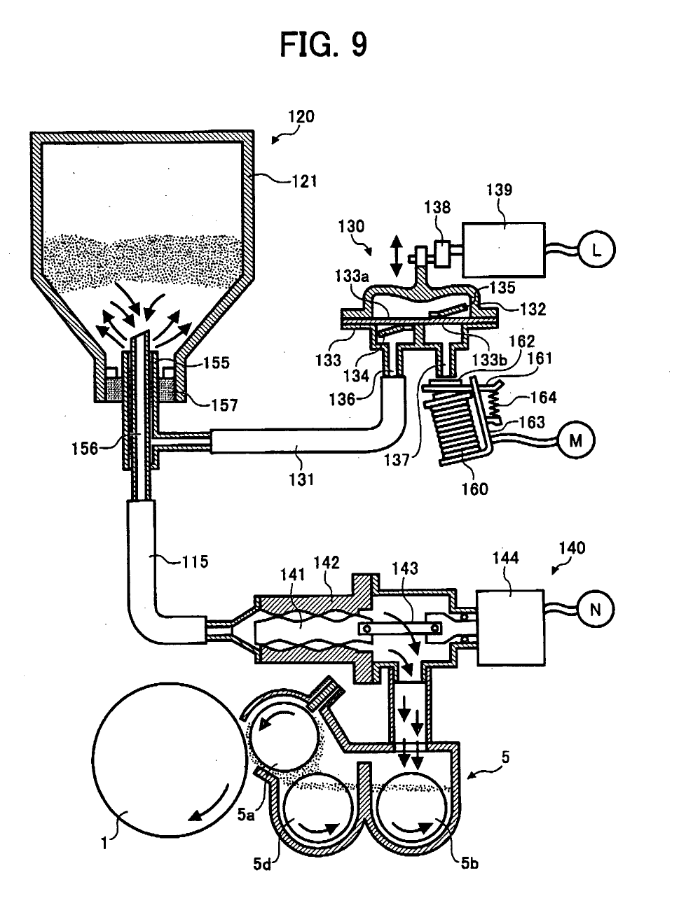

FIG. 9 is a schematic view of powder convey apparatus of other embodiments. In FIG. 9, as for the image forming device (100), an electrostatic latent image formed by photo conductor (1) is developed as toner images by development apparatus (5). This toner refilling mechanism comprises development apparatus (5), a powder pump (140), an air pump (130) and duct drawspan materials.

A powder pump (140) includes an aspiration means and a transfer tube (115) passing therethrough. Toner is supplied to development apparatus (5) by a toner receipt container (121) which received a toner as a developer receipt container. Development apparatus (5) has a developing sleeve (5a) which is opposed to photo conductor (1), and is located by agitation screw (5b) and provision screw (5d). In addition, character (5c) is doctor blade doing layer thickness of developer uniformly.

A powder pump (140) having a single-shaft eccentric screw pump of the suction type is installed is provided by development apparatus (5) as shown in FIG. 9.

The powder pump (140) has a turbine rotor (141) which made from a rigid material such as metal in the shape of the screw. Stator (142) is formed in the shape of two lines of screw from elastic bodies such as rubber.

Rotor (141), is driven by driving shaft (143) and coupled by pin joint with a drive motor (144). The single-shaft eccentric screw pump which is a powder pump (140) is able to continuously transfer with high solid-gas portion with precise amount of a toner in proportion to number of revolutions of a turbine rotor (141). Thus, when toner refilling command is emitted by image density detection, a powder pump (140) supplies a toner in a required amount to the development apparatus (5).

As shown in FIG. 9, a toner receipt container (121) is installed in the main body of image forming device and it is another unit of development apparatus (5). Circular cross section nozzle (155) is inserted in mouthpiece member (122) of toner bag. A toner receipt container (121) is set from the upper part to a set part of an image forming device body so that a discharge jet (155) is inserted in a toner outlet portion of a toner receipt container. Nozzle (155) has a toner feed passage (156) and an air feed passage (157), and, as for the interior of nozzle, it is double layer construction. As for the toner feed passage (156), toner transfer tube (115) is connected in the lower limit. In addition, an air feed passage (157) is angled rightward of a drawing in the upper part of a toner feed passage (156) and air tube (131) is gone through, and is connected with an air lift pump (130).

An air lift pump (130) is an air pump of diaphragm type as shown in FIG. 9. And diaphragm (132) is member of form of container formed in rubber or flexible plastics, and diaphragm lower part of the whole drawing adheres to a dashboard (133) with it is driven with air at the upper part in an above or the below direction by shaft (138) which is able to possess rotating shaft of a motor (139).

Air of diaphragm interior goes in and out by means of this action. In a dashboard (133), there are two places of holes an ingress hole (133b) and an egress hole (133a). A respectively flexible valve member of an exhaust-valve (134) is installed in a suction-valve (135), a drain hole (133a) to an inhalation hole (133b).

As thus described, by means of this comprising, air is provided through an inlet aperture (137) by motor (139) is sent an electric current to, and rotating, it acts to discharge air from drain hole (136). And air pipe (131) and an air feed passage (157) are passed through, and, as for the toner of a toner receipt container (121), it is spouted out air in a toner receipt container (121) by the pump when an air lift pump (130) operates. While air spouted out in mouthpiece member subject (122) of toner bag scatters a toner by passing a toner layer to achieve fluidization.

While air ejected from mouthpiece member (122) of toner bag may scatter toner by passing a toner layer without fluidization. Therefore when a powder pump (140) is operated, air is absorbed in substitution for a toner and it is possible that the toner is not transported can occur.

When a single cylinder nozzle alternately uses as a toner feed passage and an air feed passage, this phenomenon can occur.

Thus, in the present embodiment, there is an effect to prevent this problem when a valve covering and uncovering a duct is provided with. For example, all over the feed channel of air, what is provided with a make-and-break mechanism covering and uncovering the duct in arbitrary position in ducts from an inlet aperture (137) of an air duct namely an air lift pump (130) which there is with commercial electromagnetic valves to an air feed passage (157) is effective. In addition, as shown in FIG. 9, in place of an electromagnetic selector valve, the valve may cover and uncover an inlet aperture (137) of an air lift pump (130). An armature (161) is absorbed by making a coil (160) which an iron core was bound with turn on electricity, and an inlet aperture (137) of an air pump can be blocked up. In addition, a spring to return an armature (161) is (164), and (163) is a yoke forming magnetic path, and (162) expresses an elastic body constructed as in the rubber which was provided to block up an inlet aperture (137) of an air pump.

As thus described a toner refilling mechanism supplies a toner with the following step by the signal which toner concentration of development apparatus (5) lacked. At first ON assumes a coil (160) of air duct closing motion membrane (M), and a duct can be opened. An air pump (130) is turned on next, and air is poured into a toner receipt container (121), and a toner in a container is agitated, and fluidity is raised. After having turned off electrification to an air pump (130), air duct is closed as OFF in coil (160) of air duct closing motion membrane (M). A powder pump (140) is turned on, and a toner in a toner receipt container (121) is absorbed, a toner is supplied in development apparatus (5). When a toner of the deficit is supplied, a powder pump (140) is turned off.

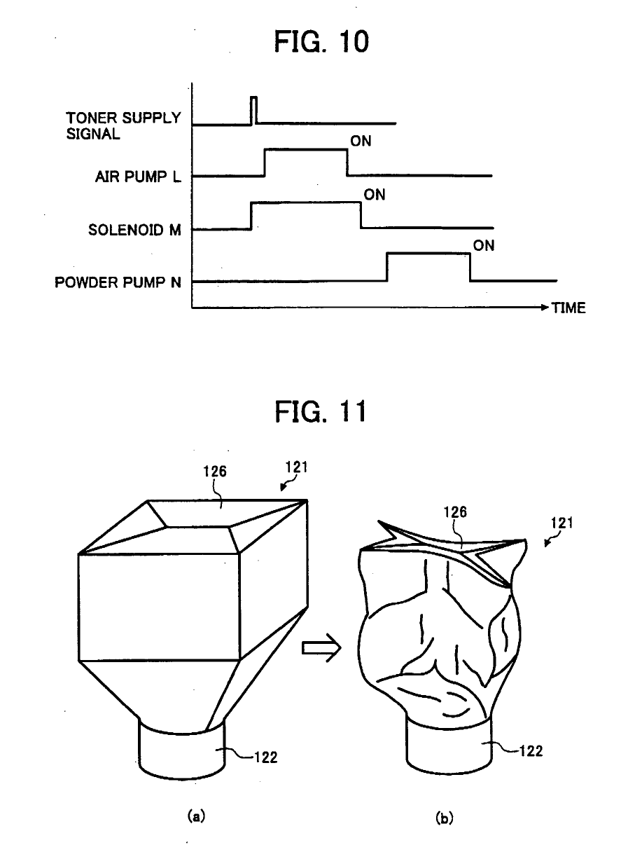

FIG. 10 is a time chart which shows timing of ON and OFF of each part at the time of the described above toner refilling. Like statement above,

Based on toner refilling signal, closing motion membrane M becomes ON, air pump L becomes ON next, impregnation of air is completed, and an air pump becomes OFF, closing motion membrane becomes OFF, screw pump becomes ON successively. After supplying a toner of a fixed quantity, OFF is become, and it is older than, and a series of actions of toner refilling complete.

By the above-mentioned constitution, when a powder pump (140) was operated, an air duct close. Problem to absorb air instead of toner can be prevented surely.

FIG. 11 shows a drawing showing a toner receipt container (121) with the use of a flexible material. It is from a bag part (126) which it was possible for in mouthpiece member subject (122) same as FIG. 1 and a material of form of flexible seat, and the architecture shows the initial state that a toner enters inside to (a), as for the container part, it is with the form that opened enough. (b) is a drawing showing the condition which has finished being supplied with an internal toner.

Bag part shrinks in decompression by absorption, and it is done a volume decrease by volume of around ⅕- 1/10 of an initial state. While supplying air and decrease volume for toner agitation, against rate of feed of air, it is necessary to drain air of higher than rate of feed of air in toner discharge. enough volume decrease confirmed that it was possible by means of an experiment hereby. A preferred embodiment of the present invention was explained as things mentioned above, the present invention is not limited by the above embodiment, and it is cut in various alteration.

The thing that contents of a developer receipt container is not limited to a toner, and even a toner and a developer comprising carrier are preferable, and, even more particularly, is preferable with a thing of one component business with a thing of two component development business in a toner is natural.

Specific example of a toner used for this powder convey apparatus (120), volume average particle is size 2-8 μm. 3-7 μm is preferable.

(1) Pigment, releasing agent, monomeric substances are dispersed in aqueous medium, and toners are produced. (2) For number average particle diameter (Dn) of a toner, fine powder content of Dn/2 or less is 20 number %. Or (3) For number average particle diameter (Dn) of a toner, content 0.7-2.0 μm of fine powder is equal to 8 number % or less.

At a minimum, if a condition of (2) is satisfied, when the member subject which can leave a movability by drive engaging of clutch and a toner or a developer touch, fine powder of the whole toner may not get between flexible region and in FIG. 8, rotor (141), stator (142), driving shaft (151) and a joint (152) may move by drive attached to clutch and it directly contact with toner.

For example when fine powder gets into the gap of driving shaft (151), movability becomes worse, and a resinous principle can begin to be dissolved and drive division may not move at all. In addition, bad influence is given such as operation stop and a movement in start when there is fine powder in a turbine rotor (141), stator (142), joint (152).

Similar can be referred to in FIG. 9. Rotor (141), stator (142), driving shaft (143) moved by drive attaching of clutch and it directly contact with toner.

Driving shaft (143) couples a turbine rotor (141) with a drive motor (144). When fine powder gets into a differential gap of the part which couples a drive motor (144) with driving shaft (143), movability becomes worse, and according to circumstance, resinous principle can begin to be dissolved and drive division may not move at all.

In addition, bad influence is given such as operation stop and a movement in start when there is fine powder in a turbine rotor (141), stator (142). In particular Like a powder pump which set a receipt container at an image forming device machine body, reliability of drive division has a great influence on toner transportation in that case of the system which drive division drives.

When a dependability of drive division declines, toner becoming block up and welding of a toner, noises can occur.

Volume average particle diameter Dv of this embodiment of the toner is at least 2-8 μm.

When volume average particle diameter Dv exceeded 8 μm, most filament reproducibility falls remarkably. The reason is because cleaning characteristics turn worse when it is under 2 μm.

When it is 3-7 μm, filament reproducibility and cleaning characteristics are satisfied together.

Average circularity of a toner with the present invention,
average circularity in 0.7−(Dn/2) μm: A
average circularity in 0.7−(Dn*2)μm: B

It is preferable to satisfy 1.0≦(1−B)/(1−A)≦4.0, and, more preferably, most preferably, 1.25≦(1−B)/(1−A)≦3.0 are 1.4≦(1−B)/(1−A)≦2.5.

Thus, when circularity of fine powder is brought close to circularity of average grain of a toner, adhesive force intervening between toners reduces, and the force which is enough between particles to untie a toner is added. That is why lowness of early stage of fluidity can be improved.

This circularity is defined as follows.
Circularity SR=(girth of A circle of area same as particle projected area/girth of Particle projection image)

The value that is almost 1.00 is become so that a toner is near to a truth ball.

Average circularity was measured by a flow-type particle image analyzer device (FPIA-2000, a product made in cis Mecs Corporation).

Water 100-150 mL which removed an impure solid body beforehand is put in a container, surface-active agents 0.1-0.5 mL is added as a dispersant, even more particularly, measurement sample around 0.1-9.5 g were added.

As for the suspension which dispersed with a sample, it was performed distributed processing with ultrasonic dispersion device for about 1-3 minutes.

Fluid dispersion concentration was adjusted to 3,000-10,000 pieces/μL, and geometry of a toner and distribution were measured.

A preferred example of process of manufacture of a toner is with a polymerization method (suspension polymerization, emulsion polymerization dispersion polymerization, emulsification aggregation, emulsification association), but these process of manufacture are not limited.

In a polymerization method, a compound having a part which can have reaction with active hydrogen radical as polymer. It is preferable to use the toner which manufactured by below process.

Polyester prepolymer having a functional group such as a nitrogen atom, polyester, and the toner composition of matter which includes pigment and releasing agent react bridging and a stretch in the presence of resin fine particles in aqueous vehicle.

When it is produced in aqueous medium with a pigment, the variance of releasing agent is superior, and a high fluidity is provided. That is why, in agent concrete supply system, it can be transferred to development apparatus without forming dead space.

More preferably, when a toner receipt container (121) was set at a toner reservoir (114) body of an image forming device (100). It is driven, and a powder pump (140) is coupled with drive division of the main body of image forming device (100).

As for the toner, what the toner is used as with part of the member subject which can leave a movability by drive engaging of clutch and an image forming device touching is desirable. When the member subject which has movability by drive engaging of clutch and a developer or a toner touch.

The powder of toners may get between movable part. Particularly, like a powder pump, in the case of the system which a receipt container is set at the main body of image forming device, and drive division drives, a dependability of drive division has a great influence on toner transportation.

When a dependability of drive division declines, toner becoming shorter and welding of a toner may be accompanied by noise production.

Present toner is preferable to having a volume-mean grain size Dv and a number-mean grain size Dn a ratio Dv/Dn of which is 1.25 and below.

Volume-mean grain size 3.0-8.0 μm and Dv/Dn of which is 1.25 and below is more preferable. It is good for heat resistant storage, hot offset resistance, and fixibility at low temp. In particular, for color imaging, good for gloss.

Generally, the less the particle diameter of the toner, the more advantageous to produce high resolution and quality images. However, it is disadvantageous for transferability and cleanability.

In addition, the toner is easy to come to adhere to transportation path of an agent transfer apparatus, by transportation by normal transportation screw, toner melted in transportation screw adheres.

However, if ratio (Dv/Dn) becomes smaller the fine diameter decreases, air transportation in a powder pump and toner congestion can be reduced.

In addition, it is preferable for this toner to make there be a finely divided particles of average particle diameter 30-300 nm on toner face. Specific example of the fine particles include inorganic fine particles and/or organic particles.

When average particle diameter of a fine particle are less than 30 nm, and it is poor at heat target or a mechanical shock, fine particles adheres in a drive joint of powder pump (140). At average particle diameter of 300 nm, fixability deteriorates because it is hindered from coming in contact with other member in toner face. In addition, drop of fluidity of a toner is remarkable, and transportation becomes difficult with a powder pump (140) of powder convey apparatus (120).

Thus, it is preferable for a primary particle diameter of this fine particles to be 30-300 nm, and it is desirable to be 80 nm-200 nm in particular.

The content of the inorganic fine particles is preferably from 0.01 to 10% by weight and more preferably from 0.01 to 2.0% by weight, based on the toner particles. Specific examples of the inorganic fine particles include silicas, aluminas, titanium oxide, barium titanate, magnesium titanate, strontium titanate, zinc oxide, tin oxide, silica sands, clays, micas, wollastnite, diatom earth, chromium oxide, cerium oxide, red iron oxide, antimony trioxide, magnesium oxide, zirconium oxide, barium sulfate, barium carbonate, calcium carbonate, silicon carbide and silicon nitride.

In addition, fine polymer particles can be used as the external additive. Specific examples of the fine polymer particles include fine particles of polymers such as polystyrene obtained by a soap free emulsionation polymerization, suspension polymerization and dispersion polymerization, polycondensation such as methacrylic ester, acrylic ester copolymers and silicone, benzoguanamine and nylon and polymer particles by thermosetting resins.

The external additives are preferably subjected to a hydrophobizing treatment to prevent deterioration of charge property and fluidity under high humidity conditions. Specific examples of the surface treatment agents include silane coupling agents, organic titanate coupling agents, sililating agents, silane coupling agents having alkyl fluoride group, organic titanate coupling agents, aluminum coupling agents, silicone oils and modified silicone oils. Hydrophobic silica and hydrophobic titanium oxide which include surface treatmented silica and/or titanium oxide are preferable.

The toner for use in the image forming apparatus of the present invention is preferably prepared by the following method:
(1) Toner constituents including at least a polyester prepolymer having a functional group having a nitrogen atom, another polyester resin, a colorant and a release agent are dissolved or dispersed in an organic solvent to prepare a toner constituent liquid; and
(2) The toner constituent liquid is dispersed in an aqueous medium including a compound which can be reacted with the polyester prepolymer to crosslink and/or elongate the polyester prepolymer and to prepare toner particles.

Toner constituents and toner manufacturing method will be described in detail.

(Modified Polyester Resin)

The toner of the present invention includes a modified polyester resin (i) as a binder resin. The modified polyester resin (i) is preferably prepared by crosslinking and/or elongating a polyester prepolymer having a functional group having a nitrogen atom with a compound such as amines. The modified polyester resin (i) is a polyester resin having a group other than the ester group; or a polyester resin in which a resin component other than the polyester resin is bonded with the polyester resin through a covalent bonding or an ionic bonding. Specifically the modified polyester resin may be polyester resins which are prepared by incorporating a functional group such as an isocyanate group, which can be reacted with a carboxyl group or a hydroxyl group, in the end portion of a polyester resin and reacting the polyester resin with a compound having an active hydrogen atom.

Suitable modified polyester resins for use as the modified polyester resin (i) include reaction products of a polyester prepolymer (A) having an isocyanate group with an amine (B). As the polyester prepolymer (A) having an isocyanate group, for example, polyesters prepared by a method in which a polycondensation product of a polyol (PO) and a polycarboxylic acid (PC) which has a group having an active hydrogen is reacted with a polyisocyanate (PIC) can be used.

Suitable groups having an active hydrogen include a hydroxyl group (an alcoholic hydroxyl group and a phenolic hydroxyl group), an amino group, a carboxyl group, a mercapto group, etc. Among these groups, alcoholic hydroxyl groups are preferred.

Suitable preferred polyols (PO) include diols (DIO) and polyols (TO) having three or more hydroxyl groups. It is preferable to use diols (DIO) alone or mixtures in which a small amount of a polyol (TO) is added to a diol (DIO).

Specific examples of the diols (DIO) include alkylene glycol (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexane dimethanol and hydrogenated bisphenol A); bisphenols (e.g., bisphenol A, bisphenol F and bisphenol S); adducts of the alicyclic diols mentioned above with an alkylene oxide (e.g., ethylene oxide, propylene oxide and butylene oxide); adducts of the bisphenols mentioned above with an alkylene oxide (e.g., ethylene oxide, propylene oxide and butylene oxide); etc.

Among these compounds, alkylene glycols having from 2 to 12 carbon atoms and adducts of bisphenols with an alkylene oxide are preferable. More preferably, adducts of bisphenols with an alkylene oxide, or mixtures of an adduct of bisphenols with an alkylene oxide and an alkylene glycol having from 2 to 12 carbon atoms are used.

Specific examples of the polyols (TO) include aliphatic alcohols having three or more hydroxyl groups (e.g., glycerin, trimethylol ethane, trimethylol propane, pentaerythritol and sorbitol); polyphenols having three or more hydroxyl groups (trisphenol PA, phenol novolak and cresol novolak); adducts of the polyphenols mentioned above with an alkylene oxide; etc.

Suitable polycarboxylic acids (PC) include dicarboxylic acids (DIC) and polycarboxylic acids (TC) having three or more carboxyl groups. It is preferable to use dicarboxylic acids (DIC) alone or mixtures in which a small amount of a polycarboxylic acid (TC) is added to a dicarboxylic acid (DIC).

Specific examples of the dicarboxylic acids (DIC) include alkylene dicarboxylic acids (e.g., succinic acid, adipic acid and sebacic acid); alkenylene dicarboxylic acids (e.g., maleic acid and fumaric acid); aromatic dicarboxylic acids (e.g., phthalic acid, isophthalic acid, terephthalic acid and naphthalene dicarboxylic acids; etc. Among these compounds, alkenylene dicarboxylic acids having from 4 to 20 carbon atoms and aromatic dicarboxylic acids having from 8 to 20 carbon atoms are preferably used.

Specific examples of the polycarboxylic acids (TC) having three or more hydroxyl groups include aromatic polycarboxylic acids having from 9 to 20 carbon atoms (e.g., trimellitic acid and pyromellitic acid).

As the polycarboxylic acid (PC), anhydrides or lower alkyl esters (e.g., methyl esters, ethyl esters or isopropyl esters) of the polycarboxylic acids mentioned above can be used for the reaction with a polyol (PO).

Suitable mixing ratio (i.e., an equivalence ratio [OH]/[COOH]) of a polyol (PO) to a polycarboxylic acid (PC) ranges from 2/1 to 1/1, preferably from 1.5/1 to 1/1 and more preferably from 1.3/1 to 1.02/1.

Specific examples of the polyisocyanates (PIC) include aliphatic polyisocyanates (e.g., tetramethylene diisocyanate, hexamethylene diisocyanate and 2,6-diisocyanate methylcaproate); alicyclic polyisocyanates (e.g., isophorone diisocyanate and cyclohexylmethane diisocyanate); aromatic didicosycantes (e.g., tolylene diisocyanate and diphenylmethane dilsocyanate); aromatic aliphatic diisocyanates (e.g., &agr;,&agr;,&agr;′,&agr;′-tetramethyl xylylene diisocyanate); isocyanurates; blocked polyisocyanates in which the polyisocyanates mentioned above are blocked with phenol derivatives, oximes or caprolactams; etc. These compounds can be used alone or in combination.

Suitable mixing ratio (i.e., [NCO]/[OH]) of a polyisocyanate (PIC) to a polyester having a hydroxyl group varies from 5/1 to 1/1, preferably from 4/1 to 1.2/1 and more preferably from 2.5/1 to 1.5/1. When the [NCO]/[OH] ratio is too large, the low temperature fixability of the toner deteriorates. In contrast, when the ratio is too small, the content of the urea group in the modified polyesters decreases, thereby deteriorating the hot-offset resistance of the toner.

The content of the constitutional component of a polyisocyanate (PIC) in the polyester prepolymer (A) having an isocyanate group at its end portion ranges from 0.5 to 40% by weight, preferably from 1 to 30% by weight and more preferably from 2 to 20% by weight. When the content is too low, the hot offset resistance of the toner deteriorates and in addition the heat resistance and low temperature fixability of the toner also deteriorate. In contrast, when the content is too high, the low temperature fixability of the toner deteriorates.

The number of the isocyanate groups included in a molecule of the polyester prepolymer (A) is at least 1, preferably from 1.5 to 3 on average, and more preferably from 1.8 to 2.5 on average. When the number of the isocyanate group is too small (less than 1 per 1 molecule) the molecular weight of the resultant urea-modified polyester decreases and thereby the hot offset resistance deteriorates.

Specific examples of the amines (B), which are to be reacted with a polyester prepolymer (A), include diamines (B1), polyamines (B2) having three or more amino groups, amino alcohols (B3), amino mercaptans (B4), amino acids (B5), and blocked amines (B6) in which the amines (B1-B5) mentioned above are blocked.

Specific examples of the diamines (B1) include aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophoron diamine); aliphatic diamines (e.g., ethylene diamine, tetramethylene diamine and hexamethylene diamine); etc.

Specific examples of the polyamines (B2) having three or more amino groups include diethylene triamine, triethylene tetramine. Specific examples of the amino alcohols (B3) include ethanol amine and hydroxyethyl aniline. Specific examples of the amino mercaptan (B4) include aminoethyl mercaptan and aminopropyl mercaptan.

Specific examples of the amino acids (B5) include amino propionic acid and amino caproic acid.

Specific examples of the blocked amines (B6) include ketimine compounds which are prepared by reacting one of the amines B1-B5 mentioned above with a ketone such as acetone, methyl ethyl ketone and methyl isobutyl ketone; oxazoline compounds, etc. Among these compounds, diamines (B1) and mixtures in which a diamine (B1) is mixed with a small amount of a polyamine (B2) are preferable.

The mixing ratio (i.e., a ratio ([NCO]/[NHx]) of the content of the prepolymer (A) having an isocyanate group to the amine (B) ranges from 1/2 to 2/1, preferably from 1.5/1 to 1/1.5 and more preferably from 1.2/1 to 1/1.2. When the mixing ratio is too low or too high, the molecular weight of the resultant urea-modified polyester decreases, resulting in deterioration of the hot offset resistance of the resultant toner.

The modified polyesters may include a urethane linkage as well as a urea linkage. The molar ratio (urea/urethane) of the urea linkage to the urethane linkage may vary from 100/0 to 10/90, preferably from 80/20 to 20/80 and more preferably from 60/40 to 30/70. When the content of the urea linkage is too low, the hot offset resistance of the resultant toner deteriorates.

The urea-modified polyester for use in the present invention can be prepared, for example, by a one-shot method or a prepolymer method. The weight-average molecular weight of the modified polyester such as the urea-modified polyester is generally 10000 or more, preferably from 20000 to 10000000, and more preferably from 30000 to 1000000. If the weight-average molecular weight is less than 10000, the hot offset resistance may deteriorate. The number-average molecular weight of the modified polyester is not specifically limited when an unmodified polyester mentioned later is used in combination and may be such a number-average molecular weight as to yield the above-specified weight-average molecular weight. If the modified polyester is used alone, the number-average molecular weight thereof is generally 20000 or less, preferably from 1000 to 10000, and more preferably from 2000 to 8000. If the number-average molecular weight exceeds 20000, the image-fixing properties at low temperatures and glossiness upon use in a full-color apparatus may deteriorate.

In the crosslinking reaction and/or elongation reaction of a polyester prepolymer (A) with an amine (B) to prepare a modified polyester (i), a reaction inhibitor can be used if desired to control the molecular weight of the resultant modified polyester.

Specific examples of such a reaction inhibitor include monoamines (e.g., diethyle amine, dibutyl amine, butyl amine and lauryl amine), and blocked amines (i.e., ketimine compounds) prepared by blocking the monoamines mentioned above.

In the present invention, not only the urea-modified polyester alone but also the unmodified polyester can be included as a toner binder with the urea-modified polyester. A combination thereof improves low temperature fixability of the resultant toner and glossiness of color images produced thereby, and the combination is more preferably used than using the urea-modified polyester alone. Further, the unmodified polyester may include modified polyester except for the urea-modified polyester.

It is preferable that the urea-modified polyester at least partially mixes with the unmodified polyester to improve the low temperature fixability and hot offset resistance of the resultant toner. Therefore, the urea-modified polyester preferably has a structure similar to that of the unmodified polyester.

A mixing ratio between the unmodified polyester and urea-modified polyester is from 20/80 to 95/5, preferably from 70/30 to 95/5, more preferably from 75/25 to 95/5, and even more preferably from 80/20 to 93/7. When the urea-modified polyester is less than 5%, the hot offset resistance deteriorates, and in addition, it is disadvantageous to have both high temperature preservability and low temperature fixability.

In the present invention, the binder resin including the unmodified polyester and urea-modified polyester preferably has a glass transition temperature (Tg) of from 45 to 65° C., and preferably from 45 to 60° C. When the glass transition temperature is less than 45° C., the high temperature preservability of the toner deteriorates. When higher than 65° C., the low temperature fixability deteriorates.

As the urea-modified polyester is present on a surface of the toner particle, the resultant toner has better heat resistance preservability than known polyester toners even though the glass transition temperature of the urea-modified polyester is low.

Suitable colorants for use in the toner of the present invention include known dyes and pigments. Specific examples of the colorants include carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussianblue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials are used alone or in combination. A content of the colorant in the toner is preferably from 1 to 15% by weight, and more preferably from 3 to 10% by weight, based on total weight of the toner.

The colorant for use in the present invention can be used as a master batch pigment when combined with a resin.

Specific examples of the resin for use in the master batch pigment or for use in combination with master batch pigment include the modified and unmodified polyester resins mentioned above; styrene polymers and substituted styrene polymers such as polystyrene, poly-p-chlorostyrene and polyvinyltoluene; or their copolymers with vinyl compounds; polymethyl methacrylate, polybutylmethacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins are used alone or in combination.

Specific examples of the charge controlling agent include known charge controlling agents such as Nigrosine dyes, triphenylmethane dyes, metal complex dyes including chromium, chelate compounds of molybdic acid, Rhodaminedyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, salicylic acid derivatives, etc. Specific examples of the marketed products of the charge controlling agents include BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, a quaternary ammonium group, etc. Among these materials, materials negatively charging a toner are preferably used.

A content of the charge controlling agent is determined depending on the species of the binder resin used, whether or not an additive is added and toner manufacturing method (such as dispersion method) used, and is not particularly limited. However, the content of the charge controlling agent is typically from 0.1 to 10 parts by weight, and preferably from 0.2 to 5 parts by weight, per 100 parts by weight of the binder resin included in the toner. When the content is too high, the toner has too large charge quantity, and thereby the electrostatic force of a developing roller attracting the toner increases, resulting in deterioration of the fluidity of the toner and decrease of the image density of toner images.

A wax for use in the toner of the present invention as a release agent has a low melting point of from 50 to 120° C. When such a wax is included in the toner, the wax is dispersed in the binder resin and serves as a release agent at a location between a fixing roller and the toner particles. Thereby, hot offset resistance can be improved without applying an oil to the fixing roller used.

Specific examples of the release agent include natural waxes such as vegetable waxes, e.g., carnauba wax, cotton wax, Japan wax and rice wax; animal waxes, e.g., bees wax and lanolin; mineral waxes, e.g., ozokelite and ceresine; and petroleum waxes, e.g., paraffin waxes, microcrystalline waxes and petrolatum. In addition, synthesized waxes can also be used. Specific examples of the synthesized waxes include synthesized hydrocarbon waxes such as Fischer-Tropsch waxes and polyethylene waxes; and synthesized waxes such as ester waxes, ketone waxes and ether waxes. In addition, fatty acid amides such as 1,2-hydroxylstearic acid amide, stearic acid amide and phthalic anhydride imide; and low molecular weight crystalline polymers such as acrylic homopolymer and copolymers having a long alkyl group in their side chain, e.g., poly-n-stearyl methacrylate, poly-n-laurylmethacrylate and n-stearyl acrylate-ethyl methacrylate copolymers, can also be used.

These charge controlling agent and release agents can be dissolved and dispersed after kneaded upon application of heat together with a master batch pigment and a binder resin, and can be added when directly dissolved and dispersed in an organic solvent.

There is case adding metallic oxide solvent dispersing element by the end of a water system medium to improve cleaning characteristics. When an appropriate amount of metallic oxide solvent dispersing element adds, it is dispersion dissolved in aqueous solvent, and generally speaking toner particle when organic solvent was removed seemed to be the pickled plum shape which has big convexoconcave in surface.

As reason, it is conceivable that it is as follows.

A metal oxide has often been used as a dry powder in the toner field. However, when a metal oxide of a powder is going to be dispersed in organic solvent agglutination often occurs. Thus a solvent and a metal oxide are scattered beforehand like sol or wet gel, and a solvent is included, uniform dispersion uses provided metal oxide solvent dispersion.

Agglutination in the whole organic solvent is suppressed, and uniform dispersion of a metal oxide is obtained. Furthermore, if metal oxide which has a pH range of 2-6 is used the metal oxide particles are attracted in an interface of a water system medium, and therefore a metal oxide particle is in a condition that a metal oxide particle covers surface around toner particle at the time of dispersion/dissolution.

In this state, while being going to maintain shape of a surface neighborhood when an organic solvent is removed an internal organic solvent is removed. As a result, generally speaking it is sphere, but shape such as the pickled plum which have big convexoconcave on the surface is become.

When a metal oxide has a pH 2-6 range and is not in a state of sol nor wet gel, as a mentioned above, it will be scattered by the end of an organic solvent and agglutinate. A large quantity of metal oxides are needed so that a metal oxide wraps up a toner particle surface neighborhood. Bad influence is given low temperature fixability. If use the metal oxide that pH is bigger than 6, orientation characteristics to an interface of a water system medium are small, and therefore a metal oxide particle is hard to form a state to cover surface around toner particle. Therefore, the metal oxide solvent dispersion is both (1) sol body or either of wet gel, and (2) it is to pH 2-6 by equal times dilution by water are desirable.

In addition, it is δ_{MS} with SP value of a solvent applied to metal oxide solvent dispersion.

When it was assumed SP (solubility parameter) value δ_{PS} of a solvent of case except the metal oxide solvent dispersion, it is desirable that δ_{MS} and relations of δ_{PS} satisfy −2.0<δ_{MS}-δ_{PS}<4.0 s to disperse metal oxide uniformly.

When SP value with a solvent dispersed binder resin is separated too much from SP value of the solvent which dispersed, each other's solvents does not mix well. The metal oxide becomes heterogeneous because a metal oxide scattered by the end of a solvent produces cohesion/deposition.

Specific Example of Metallic oxide solvent dispersing element is as follows.

Silica sol, titania sol, oxidation alumina sol, stannic oxide sol, stannic oxide-antimony sol, antimonic acid zinc sol, ceria sol, antimony pentoxide sol, cerium oxide sol, niobium oxide sol, yttrium oxide sol, the silica wetting gel which it is possible for in what polycondensation of the, in addition, metallic oxide gel does (organo), titania wetting gel, oxidation alumina wetting gel, stannic oxide wetting gel, stannic oxide—antimony wetting gel, antimonic acid zinc wetting gel, ceria wetting gel, antimony pentoxide wetting gel, cerium oxide wetting gel, niobium oxide wetting gel, yttrium oxide wetting gel, and the like can be given (organo). Organo silica sol is most preferable in that. Because it is primary particle in the whole solvent, an effect to a toner shape change depends in good and complete to toner particle formation, and dispersibility of metallic oxide grows big.

From dispersibility, stability and productivity, an organo silica sol is used as is more desirable.

Organo silica sol is one part of silanol group of a particle surface is the condition that silanization processed colloidal silica disperses in a stable condition in organic solvent or the that of solution.

About detailed description of Organo silica sol and its process, Japanese Patent Laid-Open No. 11-43319 Official Gazette is incorporated by reference herein.

The thus prepared toner particles may be mixed with an external additive to assist in improving the fluidity, developing property and charging ability of the toner particles. Suitable external additives include particulate inorganic materials. It is preferable for the particulate inorganic materials have a primary particle diameter of from 5 μm to 2 μm, and more preferably from 5 μm to 500 μm. In addition, it is preferable that the specific surface area of such particulate inorganic materials measured by a BET method is from 20 m2/g to 500 m2/g. The content of the external additive is preferably from 0.01% to 5% by weight, and more preferably from 0.01% to 2.0% by weight, based on total weight of the toner.

Specific examples of such inorganic particulate materials include silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc. Among these particulate inorganic materials, a combination of a hydrophobic silica and a hydrophobic titanium oxide is preferably used. In particular, when a hydrophobic silica and a hydrophobic titanium oxide each having an average particle diameter not greater than 50 nm are used as an external additive, the electrostatic force and van der Waals' force between the external additive and the toner particles are improved, and thereby the resultant toner composition has a proper charge quantity. In addition, even when the toner composition is agitated in a developing device, the external additive is hardly released from the toner particles, and thereby image defects such as white spots and image omissions are hardly produced. Further, the quantity of particles of the toner composition remaining on image bearing members can be reduced.

When particulate titanium oxides are used as an external additive, the resultant toner composition can stably produce toner images having a proper image density even when environmental conditions are changed. However, the charge rising properties of the resultant toner tend to deteriorate. Therefore the addition quantity of a particulate titanium oxide is preferably smaller than that of a particulate silica, and in addition the total addition amount thereof is preferably from 0.3 to 1.5% by weight based on weight of the toner particles not to deteriorate the charge rising properties and to stably produce good images without toner cloud (i.e., toner scattering).

Now, the method for manufacturing the toner for use in the present invention is disclosed. However, the manufacturing method is not limited to the examples presented herein below.

(Method of Manufacturing a Toner)

(1) First, toner constituents including a colorant, an unmodified polyester resin, a polyester prepolymer having an isocyanate group, and a release agent are dissolved or dispersed in an organic solvent to prepare a toner constituent liquid.

Suitable preferred organic solvents include volatile organic solvents having a boiling point less than 100° C. Since such solvent can be easily removed from the resultant toner particle dispersion.

Specific examples of the organic solvents include toluene, xylene, benzene, carbon tetrachloride, methylene chloride, 1,2-dichloroethane, 1,1,2-trichloroethane, chloroform, monochlorobenzene, dichloroethylidene, methyl acetate, ethyl acetate, methyl ethyl ketone, methyl isobutyl ketone, etc. These can be used alone or in combination. In particular, aromatic solvents such as toluene and xylene, and halogenated hydrocarbons such as 1,2-dichloroethane, chloroform and carbon tetrachloride are preferably used.

The addition quantity of the organic solvent is from 0 to 300 parts by weight, preferably from 0 to 100 parts by weight and more preferably from 25 to 70 parts by weight, per 100 parts by weight of the polyester prepolymer used.

(2) The toner constituent liquid is emulsified in an aqueous medium in the presence of a surfactant and a particulate resin.

Suitable aqueous media include water, and mixtures of water with alcohols (such as methanol, isopropanol and ethylene glycol), dimethylformamide, tetrahydrofuran, cellosolves (such as methyl cellosolve) and lower ketones (such as acetone and methyl ethyl ketone).

The mixing ratio (A/T) of the aqueous medium (A) to the toner constituent liquid (T) is from 51000 to 2000/100 by weight, and preferably from 100/100 to 1000/100 by weight. When the content of the aqueous medium is too low, the toner constituent liquid may not be well dispersed, and thereby toner particles having a desired particle diameter may not be produced. In contrast, when the content of the aqueous medium is too high, the manufacturing cost of the toner increases.

When the toner constituent liquid is dispersed in an aqueous medium, a dispersant can be preferably used to prepare a stable dispersion.

Specific examples of the surfactants include anionic surfactants such as alkylbenzene sulfonic acid salts, [alpha]-olefin sulfonic acid salts, and phosphoric acid salts; cationic surfactants such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surfactants such as fatty acid amide derivatives, polyhydric alcohol derivatives; and ampholytic surfactants such as alanine, dodecyldi(aminoethyl)glycin, di)octylaminoethyle)glycin, and N-alkyl-N,N-dimethylammonium betaine.

By using a surfactant having a fluoroalkyl group, a good dispersion can be prepared even when a small amount of the surfactant is used. Specific examples of the anionic surfactants having a fluoroalkyl group include fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4) sulfonate, sodium 3-{omega-fluoroalkanoyl(C₆-C8)—N-ethylamino}-1-propanesulfonate, fluoroalkyl(C11-C20) carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonyl glycin, monoperfluoroalkyl(C6-C16)ethylphosphates, etc.

Specific examples of the marketed products of such surfactants having a fluoroalkyl group include SURFLON(R)S-111, S-112 and S-113, which are manufactured by Asahi Glass Co., Ltd.; FRORARD(R) FC-93, FC-95, FC-98 and FC-129, which are manufactured by Sumitomo 3M Ltd.; UNIDYNE(R) DS-101 and DS-102, which are manufactured by Daikin Industries, Ltd.; MEGAFACE(R) F-110, F-120, F-113, F-191, F-812 and F-833 which are manufactured by Dainippon Ink and Chemicals, Inc.; ECTOP(R) EF-102, 103, 104, 105, 112, 123A, 306A, (11), 201 and 204, which are manufactured by Tohchem Products Co., Ltd.; FUTARGENT(R) F-100 and F150 manufactured by Neos; etc.

Specific examples of the cationic surfactants having a fluoroalkyl group include primary, secondary and tertiary aliphatic amino acids, aliphatic quaternary ammonium salts (such as perfluoroalkyl(C6-C10)sulfoneamidepropyltrimethylammonium salts), benzalkonium salts, benzetonium chloride, pyridinium salts, imidazolinium salts, etc., all of which have a fluoroalkyl group Specific examples of commercially available products of these elements include SURFLON(R)S-121 (from Asahi Glass Co., Ltd.); FRORARD(R) FC-135 (from Sumitomo 3M Ltd.); UNIDYNE(R) DS-202 (from Daikin Industries, Ltd.); MEGAFACE(R) F-150 and F-824 (from Dainippon Ink and Chemicals, Inc.); ECTOP(R) EF-132 (from Tohchem Products Co., Ltd.); FUTARGENT(R) F-300 (from Neos); etc.

In addition, particulate polymers can be added to stabilize the resultant mother toner particles formed in an aqueous medium. Therefore it is preferred that a particulate polymer be added to the aqueous medium such that the surface of the mother toner particles are covered with the particulate polymer at a covering ratio of from 10 to 90%.

Specific examples of the particulate polymers include particulate polymethyl methacylate having a particle diameter of from 1 to 3 μm, particulate polystyrene having a particle diameter of from 0.5 to 2 μm, particulate styrene-acrylonitrile copolymers having a particle diameter of 1 μm, etc. Specific examples of the marketed particulate polymers include PB-200H (from Kao Corp.), SGP (Soken Chemical & Engineering Co., Ltd.), TECHNOPOLYMER(R) SB (Sekisui Plastics Co., Ltd.), SPG-3G (Soken Chemical & Engineering Co., Ltd.), MICROPEARL(R) (Sekisui Fine Chemical Co., Ltd.), etc.

In addition, an inorganic dispersant can be added to the aqueous medium. Specific examples of the inorganic dispersants include tricalcium phosphate, calcium carbonate, titanium oxide, colloidal silica, hydroxyapatite, etc.

Further, it is possible to stably disperse toner constituents in an aqueous medium using a polymeric protection colloid in combination with the inorganic dispersants and/or particulate polymers mentioned above.

Specific examples of such protection colloids include polymers and copolymers prepared using monomers such as acids (e.g., acrylic acid, methacrylic acid, [alpha]-cyanoacrylic acid, [alpha]-cyanomethacrylic acid, itaconic acid, crotonic acid, fumaric acid, maleic acid and maleic anhydride), acrylic monomers having a hydroxyl group (e.g., [beta]-hydroxyethyl acrylate, [beta]-hydroxyethyl methacrylate, [beta]-hydroxypropyl acrylate, [beta]-hydroxypropyl methacrylate, [gamma]-hydroxypropyl acrylate, [gamma]-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine).

In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters), and cellulose compounds such as methyl cellulose, hydroxyethyl cellulose and hydroxypropyl cellulose, can also be used as the polymeric protective colloid.

The dispersion method is not particularly limited, and low speed shearing methods, high speed shearing methods, friction methods, high pressure jet methods, ultrasonic methods, etc. can be used. Among these methods, high speed shearing methods are preferable because particles having a particle diameter of from 2 μm to 20 μm can be easily prepared. At this point, the particle diameter (2 to 20 μm) means a particle diameter of particles including a liquid.

When a high speed shearing type dispersion machine is used, the rotation speed is not particularly limited, but the rotation speed is typically from 1,000 to 30,000 rpm, and preferably from 5,000 to 20,000 rpm. The dispersion time is not also particularly limited, but is typically from 0.1 to 5 minutes. The temperature in the dispersion process is typically from 0 to 150° C. (under pressure), and preferably from 40 to 98° C.

(3) At the same time when a toner constituent is dispersed in an aqueous medium, an amine (B) is added to the aqueous medium to be reacted with the polyester prepolymer (A) having an isocyanate group.

This reaction accompanies crosslinking and/or elongation of the molecular chains of the polyester prepolymer (A). The reaction time is determined depending on the reactivity of the amine (B) with the polyester prepolymer used, but is typically from 10 minutes to 40 hours, and preferably from 2 to 24 hours. The reaction temperature is from 0 to 150° C., and preferably from 40 to 98° C. In addition, known catalysts such as dibutyltin laurate and dioctyltin laurate, can be used for the reaction, if desired.

(4) After the reaction, the organic solvent is removed from the resultant dispersion (emulsion, or reaction product), and then the solid components are washed and then dried. Thus, a mother toner is prepared.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

Implant of charge control agent and external of fine inorganic particles are performed by the well-known method using a mixer. By the above, a sharp toner of atomizing distribution can be got at a small diameter easily.

Even more particularly, if strongly agitated when in a process removing organic solvent, shape can be controlled between form of rugby ball taking its ease from a true ball type.

Even more particularly, surface of morphology can be controlled the shape between pickled plum and satiny. Shape of a toner which concerning the present invention is generally sphere, and shape of a toner can be presented by shape provision are as below.

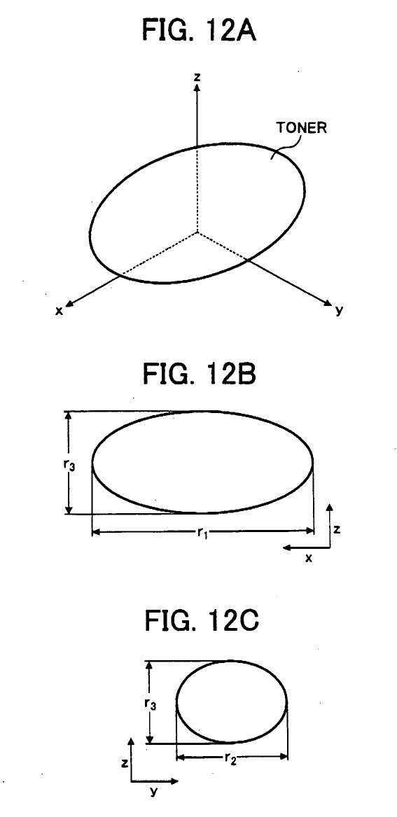

FIG. 12 shows a drawing showing shape typically of a toner concerning the present invention.

A toner generally sphere-shaped in FIG. 12 extended shaft r1, brachyaxis r2, single sheet thickness r3 (but it is assumed r1≧r2≧r3.)

When it appears, and it is prescribed, as for the toner of the present invention, preferred a thing in 0.7-1.0 extent ratio (r3/r2) (cf. (c)) with thickness and brachyaxis with 0.5-1.0 ratio (r2/r1) (cf. (b)) with brachyaxis and extended shaft. Dot reproducibility and transcript efficiency are inferior so that ratio (r2/r1) with extended shaft and brachyaxis is separated from form of truth sphere with under 0.5 high-grade picture quality is not provided.

In addition, ratio (r3/r2) with a single sheet thickness and brachyaxis is under 0.7, and it becomes near, and the high transcript rate that seems to be sphere toner is not provided in flat geometry.

Ratio (r3/r2) with a single sheet thickness and brachyaxis is 1.0, and it is with the body of revolution which assumes extended shaft axis of revolution in particular flowability of toner can be improved.

In addition, r1, r2, r3 change angle of visual field with scanning electron microscope (SEM), and photography is taken while observing it was measured.

A toner produced by the above can be used as one-component magnetism toner without magnetic carrier or nonmagnetic toner.

For magnetic carrier, it is ferrite including metal of divalence such as iron, magnetic iron ore, Mn, Zn, Cu, and weight average particle size D420-100 μm is preferable.

When average particle diameter is under 20 μm, carrier adhesion is easy to occur in photo conductor (1) at the time of development, when over 100 μm, mixing property with a toner is low, and an electro static charge amount of a toner is insufficient, and electro static charge defectiveness at the time of continuous service is easy to be produced.

In addition, Cu ferrite including Zn is preferable because saturation magnetization is high, but it can be put together in process of an image forming device, and it can be selected appropriately.

Magnetism carrier may be coated with a resin.

A can resin is not limited in particular, and, by way of example there are silicone resin, styrene-acryl resin, fluororesin, olefin resin.

The process of manufacture dissolves a coating resin by the end of a solvent it is sprayed by the end of a fluidized bed, and it may be coated on a core, after having made, in addition, a resin particle bond to nuclear particle electrostatically by thermofusion, and it may be coated.

Preferably, as for the coated resinous single sheet thickness, 0.3-4 μm are preferable 0.05-10 μm.

In addition, an image forming device (100) of the present invention is selected from photo conductor (1) and charge device (3), developing device (5), a cleaning unit (7), at a minimum, device of higher than 1 including developing device (5) is at one, and is supported, and a removable process cartridge (2) is included.

Developer, exchange of developing device (5) are facilitated, and the main body of image forming device (100) can be used hereby for maximum period.

### EXAMPLES

### Manufacturing Example 1

Preparation of Polymer Dispersion

Below materials were took up at 70° C.
styrene monomer: 185 parts
butyl acrylate: 15 parts
carnauba wax: 8 parts
phthalocyanine blue: 1 part
divinylbenzene: 2 parts
azobis (isobutyronitrile): 8 parts.

In a reaction container, the materials were mixed for 15 minute using a TK HOMOMIXER (manufactured by Tokushu Kika Kogyo Co., Ltd.) at 65° C.

Aqueous phase 1

| | | |
|---|---|---|
| ion-exchanged water: | 1000 | parts |
| colloidal silica | 4.2 | parts |
| (aeroll #200): | | |

Above materials were dispersed and kept at 60° C. and then Aqueous phase 1 was prepared

Polymer dispersion and the monomer mixture were mixed for 60 minutes using a TK HOMOMIXER (manufactured by Tokushu Kika Kogyo Co., Ltd.) at 4000 rpm.

Above mixture was stirred by a Three-one Motor stirrer (trade name, available from Shinto Kagaku K.K.) with paddle blade. After that, dispersant was removed and washed. After washing the filter cake was dried for 48 hours at 45° C. using a circulating drier. The dried cake was sieved using a screen having openings of 150 μm. Thus a mother toner 1 was prepared.

### EXAMPLES

### Example 1

Mother toner 1 was classified by elbow jet (made by Matsubo kabushikikaisya).

200 parts of classified mother toner and inorganic particles as below were mixed in a Henshel mixer (made in MITSUI MINING COMPANY, LTD.) at 45 m/s for 2 minutes.

0.3 part of inorganic particles A (BET 200 m2/g): 100 parts of Silica particles surface-treated with 9 parts of hexamethylenedisilazane

1.8 part of inorganic particles B(BET 50 m2/g): 100 parts of Silica particles surface-treated with 8 parts of silicon oil above obtained mixed toner were treatment by using a Hybridization system (manufactured by Nara Machinery Co. Ltd.).

The treatments are performed at a system max temperature of 29° C. and at 50 m/s for 3 minutes.

In addition, 100 parts of obtained toner and inorganic particles as below were mixed in a Henshel mixer (made in MITSUI MINING COMPANY, LTD.) at 45 m/s for 3 minutes.

1.0 part of inorganic particles A(BET 200 m2/g): 100 parts of Silica particles surface-treated with 9 parts of hexamethylenedisilazane

0.5 part of inorganic particles C(BET 115 m2/g): 100 parts of anatase-type Ti particles surface-treated with 12 parts of isobutyl trimethoxysilane obtained toner were sieved using a screen having openings of 75 μm. Thus, toner 1 was prepared.

### Example 2

Mother toner 1 were classified by elbow jet (made by Matsubo kabushikikaisya).

200 parts of classified mother toner and inorganic particles as below were mixed in a Henshel mixer (made in MITSUI MINING COMPANY, LTD.) at 45 m/s for 2 minutes.

0.3 part of inorganic particles A(BET 200 m2/g): 100 parts of silica particles surface-treated with 9 parts of hexamethylenedisilazane

2.4 part of resin fine particles B (volume average particle size:o.o8 μm): synthesis (soap free polymerization) from styrene methacrylic acid. Above obtained mixed toner were treatment by using a Hybridization system (manufactured by Nara Machinery Co. Ltd.).

The treatments are performed at a system max temperature of 31° C. and at 40 m/s for 5 minutes.

In addition, 100 parts of obtained toner and inorganic particles as below were mixed in a Henshel mixer (made in MITSUI MINING COMPANY, LTD.) at 45 m/s for 3 minutes.

1.2 part of inorganic particles A (BET 200 m2/g): 100 parts of Silica particles surface-treated with 9 parts of hexamethylenedisilazane

0.5 part of inorganic particles C (BET 115 m2/g): 100 parts of anatase-type Ti particles surface-treated with 12 parts of isobutyl trimethoxysilane

Obtained toner were sieved using a screen having openings of 75 μm. Thus, toner 2 was prepared.

### Comparative Example 1

200 parts of mother toner 1 and inorganic particles as below were mixed in a Henshel mixer (made in MITSUI MINING COMPANY, LTD.) at 45 m/s for 3 minutes.

1.2 part of inorganic particles A (BET 200 m2/g): 100 parts of silica particles surface-treated with 9 parts of hexamethylenedisilazane; and

0.5 part of inorganic particles C (BET 115 m2/g): 100 parts of anatase-type Ti particles surface-treated with 12 parts of isobutyl trimethoxysilane. The mixture was then sieved using a screen having openings of 75 μm. Thus, toner 3 was prepared.

### Comparative example 2

200 parts of mother toner 1 and inorganic particles as below were mixed in a Henshel mixer (made in MITSUI MINING COMPANY, LTD.) at 45 m/s for 3 minutes.
1.2 part of inorganic particles A (BET 200 m2/g): 100 parts of Silica particles surface-treated with 9 parts of hexamethylenedisilazane;
1.4 part of inorganic particles B (BET 50 m2/g): 100 parts of Silica particles surface-treated with 8 parts of silicon oil;
0.5 part of inorganic particles C (BET 115 m2/g): 100 parts of anatase-type Ti particles surface-treated with 12 parts of isobutyl trimethoxysilane

The mixture was then sieved using a screen having openings of 75 μm. Thus, Toner 4 was prepared.

Synthesis of Low Molecular Weight Polyester

### Manufacturing Example 2

In a reaction container equipped with a condenser, a stirrer and a pipe from which a nitrogen gas was supplied to the container, 319 parts of an adduct of bisphenol A with 2 mols of propyleneoxide, 243 parts of terephthalic acid, 53 parts of adipic acid, and 2 parts of dibutyl tin oxide were mixed.

Then the mixture was reacted for 8 hours at 230° C. under a normal pressure. Then the reaction was further performed for 5 hours under a reduced pressure of from 10 mmHg to 15 mmHg. In addition, 7 parts of trimellitie anhydride were added thereto and the mixture was reacted for 2 hours at 180° C. under a normal pressure. Thus, a low molecular weight polyester 1 having a number average molecular weight of 2000, a weight average molecular weight of 6600, a glass transition temperature (Tg) of 46° C., and an acid value of 1.3 was obtained.

Preparation of Master Batch

1200 parts of water, 800 parts of carbon black, and 1200 parts of Low Molecular Weight Polyester were mixed in a Henshel mixer (made in MITSUI MINING COMPANY, LTD.). This mixture was kneaded for 30 minutes at 150° C. using a two-roll mill.

After the mixture was rolled and cooled, the kneaded mixture was pulverized. Thus, a master batch 1 was prepared.

(Synthesis of Organic Fine Particle Emulsion)

680 parts of water, 11 parts of a sodium salt of an adduct of a sulfuric ester with ethyleneoxide methacrylate (ELEMINOL RS-30 from Sanyo Chemical Industries, Ltd.), 69 parts of styrene, 110 parts of methacrylate, 69 parts of butylacrylate and 1 part of persulfate ammonium were mixed in a reactor vessel including a stirrer and a thermometer, and the mixture was stirred for 15 min at 400 rpm to prepare a white emulsion therein.

The white emulsion was heated to have a temperature of 75° C. and reacted for 5 hrs. Further, 30 parts of an aqueous solution of persulfate ammonium having a concentration of 1% were added thereto and the mixture was reacted for 5 hrs at 75° C. to prepare an aqueous dispersion a [i.e., fine particle dispersion liquid] of a vinyl resin (a copolymer of a sodium salt of an adduct of styrene-methacrylate-butylacrylate-sulfuric ester with ethyleneoxide methacrylate). The fine particle dispersion liquid was measured by LA-920 to find a volume-average particle diameter thereof was 0.11 μm. A part of the fine particle dispersion liquid was dried to isolate a resin component therefrom. The resin component had a Tg of 150° C.

(Preparation for an Aqueous Phase)

240 parts of water, 13 parts of the fine particle dispersion liquid, 40 parts of an aqueous solution of sodium dodecyldiphenyletherdisulfonate having a concentration of 50% (ELEMINOL MON-7: from Sanyo Chemical Industries, Ltd.) and 25 parts of ethyl acetate were mixed and stirred to prepare a lacteous liquid an [i.e., aqueous phase 2].

Preparation of Prepolymer and Intermediate Polyester

### Manufacturing Example 2

In a reaction container wquipped with a condenser, a stirrer and a pipe from which a nitrogen gas was supplied to the container, 682 parts of an adduct of bisphenol A with 2 moles of ethyleneoxide, 81 parts of an adduct of bisphenol A with 2 moles of propyleneoxide, 283 parts of terephthalic acid, 22 parts of trimellitic anhydride, and 2 parts of dibutyl tin oxide were mixed. Then the mixture was reacted for 8 hours at 230° C. under a normal pressure. Then the reaction was further performed for 5 hours under a reduced pressure of from 10 to 15 mmHg.

Thus, an intermediate polyester was prepared. The intermediate polyester had a number average molecular weight of 9600, a glass transition temperature of 55° C. Acid value of 0.5 and a hydroxyl value of 51.

In a reaction container equipped with a condenser, a stirrer and a pipe from which a nitrogen gas was supplied to the container, 411 parts of the intermediate polyester 1.89 parts of isophorodiisocyanate and 500 parts of ethyl acetate were added. The mixture was reacted for 5 hours at 100° C.

Thus, a prepolymer was prepared. The prepolymer included a free isocyanate group in an amount of 1.60% by weight.

The solid content of the prepolymer was 50% when measured by hcating the dispersion at 130° C. for 30 minutes.

Synthesis of Ketimine

### Manufacturing Example 7

In a reaction container equipped with a stirrer and a thermometer, 170 parts of isophoronediamine and 75 parts of methylethyl ketone were mixed. The mixture was reacted for 5 hours at 50° C. Thus, a ketimine compound was prepared. The ketimine compound had an amine value of 423.

Preparation of Oil Phase

### Manufacturing Example 8-1

In a reaction container equipped with a stirrer and a thermometer, 50 parts of synthetic ester wax low molecular weight polyester, 20 parts of a metal complex of salicylic acid serving as charge as a charge controlling agent (E-84 from Orient Chemical Industries Co., Ltd.) and 330 parts of ethyl acetate were mixed. The mixture was heated at 80° C. for 5 hours while agitated and then cooled to 30° C. While taking one hour. Then 250 parts of the master batch 1 and 330 parts of ethyl acetate were added thereto to be mixed for 1 hour.

Thus, a toner constituent solution 1 was prepared.

Then 132 parts of the toner constituent solution 1 were contained in a container, and then dispersed using a bead mill (ULTRAVISCOMILL from AIMEX) under the following conditions:
Liquid feeding speed: 1 kg/hr,
Disc rotation speed: 6 m/sec,
Diameter of beads: 0.5 mm,
Filling factor: 80% by volume, and
Repeat number of dispersion treatment: 6-24 times.

Thus, the pigment and wax were dispersed. Then 200 parts of a 70% ethyl acetate solution of the low molecular weight polyester 1, 80 parts of ethyl acetate were added thereto, and the mixture was dispersed under the conditions mentioned above except that the repeat number of the dispersion treatment was changed to 1 time.

Thus, a pigment/wax dispersion 1 was prepared.

The solid content of the pigment/wax dispersion 1 was 50% when measured by heating the dispersion at 150° C. for 45 minutes.

### Manufacturing Example 9-1

The following components were contained in a contained to be mixed for 1 minute using a TK HOMOMIXER (manufactured by Tokushu Kika Kogyo Co., Ltd.) at a revolution of 5,000 rpm.
1. Pigment/wax dispersion 1 212 parts
2. Prepolymer 1 31 parts
3. Ketimine compound 2.8 parts

Then, 360 parts of the aqueous phase 1 were added thereto and the mixture was dispersed for 20 minute using a TK HOMOMIXER at a revolution of 13,000 rpm. Thus, an emulsion slurry 1 was prepared.

In a container equipped with a stirrer and a thermometer, the emulsion slurry 1 was added and then was heated at 30° C. for 8 hour to remove the solvents therefrom. Then the slurry was aged at 60° C. for 8 hours to prepare a dispersion slurry 1.

Washing and Drying

100 parts of the emulsion slurry 1 were filtered by filtering under a reduced pressure. After washing the filter cake 1 was dried for 48 hours at 45° C. using a circulating drier. The dried cake was sieved using a screen having openings of 75 μm. Thus a mother toner 2 was prepared.

### Example 3

100 parts of mother toner 2 and inorganic particles as below were mixed in a Henshel mixer (made in MITSUI MINING COMPANY, LTD.) at 45 nm/s for 3 minutes.
0.3 part of inorganic particles A (BET 200 m2/g): 100 parts of silica particles surface-treated with 9 parts of hexamethylenedisilazane;
1.8 part of inorganic particles B (BET 50 m2/g): 100 parts of silica particles surface-treated with 8 parts of silicon oil;

The toner was hybridizated by HYBRIDIZATION SYSTEM (manufactured by Nara Machine Co., Ltd.), at 50 m/s for 3 minute in max 30° C. within the system. In addition, abtained 100 parts of Toner and below inorganic particles were mixed in a Henshel mixer (made in MITSUI MINING COMPANY, LTD.) at 45 m/s for 3 minutes.
1 part of inorganic particles A (BET 200 m2/g): 100 parts of silica particles surface-treated with 9 parts of hexamethylenedisilazane;
0.5 part of inorganic particles C (BET 115 m2/g): 100 parts of anatase-type Ti particles surface-treated with 12 parts of isobutyl trimethoxysilane;

Obtained toner were sieved using a screen having openings of 75 μm. Thus, toner 5 was prepared.

### Manufacturing Example 9-2

The following components were contained in a contained to be mixed for 1 minute using a TK HOMOMIXER (manufactured by Tokushu Kika Kogyo Co., Ltd.) at a revolution of 5,000 rpm.

| | | |
|---|---|---|
| 1. Pigment/wax dispersion 1 | 206 | parts |
| 2. Prepolymer 1 | 30 | parts |
| 3. 20 wt % Organo silica sol | 10 | parts |
| 4. Ketimine compound | 2.8 | parts |

Then, 360 parts of the aqueous phase 1 were added thereto and the mixture was dispersed for 20 minute using a TK HOMOMIXER at a revolution of 13,000 rpm. Thus, an emulsion slurry 2 was prepared.

In a container equipped with a stirrer and a thermometer, the emulsion slurry 2 was added and then was heated at 30° C. for 8 hour to remove the solvents therefrom. Then the slurry was aged at 60° C. for 8 hours to prepare a dispersion slurry 2.

Washing and Drying

100 parts of the emulsion slurry 1 were filtered by filtering under a reduced pressure. After washing the filter cake 1 was dried for 48 hours at 45° C. using a circulating drier. The dried cake was sieved using a screen having openings of 75 μm. Thus a mother toner 3 was prepared.

### Example 4

100 parts of mother toner 3 and inorganic particles as below were mixed in a Henshel mixer (made in MITSUI MINING COMPANY, LTD.) at 45 m/s for 3 minutes.
1.2 part of inorganic particles A (BET 200 m2/g): 100 parts of silica particles surface-treated with 9 parts of hexamethylenedisilazane;
0.5 part of inorganic particles C (BET 115 m2/g): 100 parts of anatase-type Ti particles surface-treated with 12 parts of isobutyl trimethoxysilane;

Obtained toner were sieved using a screen having openings of 75 μm. Thus, toner 6 was prepared.

Preparation for Master Batch.

### Manufacture Example 3-2

1,200 parts of water, 800 parts of Cu-phthalocyanine 15:3,
1,200 parts of a low-molecular polyester were mixed by a Henschel mixer from Mitsui Mining Co., Ltd. After the mixture was kneaded by a two-roll mil having a surface temperature of 150° C. for half hr, the mixture was extended by applying pressure, cooled and pulverized by a pulverizer to prepare a master batch 2.
   Preparation for Master Batch.

### Manufacture Example 3-3

1,200 parts of water, 800 parts of C.I. Pigment Yellow 155,
1,200 parts of a low-molecular polyester were mixed by a Henschel mixer from Mitsui Mining Co., Ltd. After the mixture was kneaded by a two-roll mil having a surface temperature of 150° C. for half hr., the mixture was extended by applying pressure, cooled and pulverized by a pulverizer to prepare a master batch 3.
   Preparation for Master Batch.

### Manufacture Example 3-4

1,200 parts of water, 800 parts of C.I. Pigment red 184,
1,200 parts of a low-molecular polyester were mixed by a Henschel mixer from Mitsui Mining Co., Ltd. After the mixture was kneaded by a two-roll mil having a surface temperature of 150° C. for half hr., the mixture was extended by applying pressure, cooled and pulverized by a pulverizer to prepare a master batch 4.

### Manufacture Example 8-2

The procedure for preparation of the pigment/wax dispersion 1 (Manufacture example 8-1) was repeated except that the master batch 1 was replaced with the master batch 2. Thus, pigment/wax dispersion 2 was prepared.

### Manufacture Example 8-3

The procedure for preparation of the pigment/wax dispersion 1 (Manufacture example 8-1) was repeated except that the master batch 1 was replaced with the master batch 3. Thus, pigment/wax dispersion 3 was prepared.

### Manufacture Example 8-4

The procedure for preparation of the pigment/wax dispersion 1 (Manufacture example 8-1) was repeated except that the master batch 1 was replaced with the master batch 4. Thus, pigment/wax dispersion 4 was prepared.

### Manufacture Example 9-3

The procedure for preparation of the mother toner (manufacture example 9-1) was repeated except that the (manufacture example 9-2) of pigment/wax dispersion 1 was replaced with the pigment/wax dispersion 2. Thus, a mother toner 4 was prepared.

### Manufacture Example 9-4

The procedure for preparation of the mother toner (manufacture example 9-1) was repeated except that the (manufacture example 9-2) of pigment/wax dispersion 1 was replaced with the pigment/wax dispersion 3. Thus, a mother toner 5 was prepared.

### Manufacture Example 9-5

The procedure for preparation of the mother toner (manufacture example 9-1) was repeated except that the (manufacture example 9-2) of pigment/wax dispersion 1 was replaced with the pigment/wax dispersion 4. Thus, a mother toner 6 was prepared.

### Example 5

The procedure (Example 4) was repeated except that the example 4 of mother toner 3 was replaced with the mother toner 4. Thus, a mother toner 7 was prepared and tested.

### Example 6

The procedure (Example 4) was repeated except that the example 4 of mother toner 3 was replaced with the mother toner 5. Thus, a mother toner 8 was prepared and tested.

### Example 7

The procedure (Example 4) was repeated except that the example 4 of mother toner 3 was replaced with the mother toner 6. Thus, a mother toner 9 was prepared and tested.

The evaluation items are as follows.

(1) Particle Diameter (Dv, Dn)

The particle diameter (i.e., volume average particle diameter and number average particle diameter) of a toner was measured with a particle diameter measuring instrument, COULTER COUNTER TAII, manufactured by Coulter Electronics, Inc., which was equipped with an aperture having a diameter of 100 μm.

(2) Spherical Degree (S.D.)

The spherical degree can be measured by a flow type particle image analyzer FPIA-2100 manufactured by To a Medical Electronics Co., Ltd. The average spherical degree of each toner was determined.

The specific procedure is as follows:
1) a surfactant serving as a dispersant, preferably 0.1 ml to 5 ml of an alkylbenzenesulfonic acid salt, is added to 100 ml to 150 ml of water from which solid impurities had been removed;
2) 0.1 g to 0.5 g of a sample to be measured is added into the mixture prepared in (1);
3) the mixture prepared in (2) is subjected to an ultrasonic dispersion treatment for about 1 to 3 minutes such that the concentration of the particles is 3,000 to 10,000 particles per microlitter; and
4) the shape and average particle diameter distribution of the sample are determined using the instrument mentioned above.

(3) Charge Quantity (Q/M)

6 grams of a developer were contained in a closed metal cylinder and subjected to a blow-off treatment to determine the charge quantity of the toner. In this case, the toner concentration of the developer was adjusted so as to range from 4.5% to 5.5% by weight.

(4) Fixability

Imagio Neo 325 was modified to have a fixing belt, and a solid image was produced on an ordinary transfer paper and a thick transfer paper, i.e., TYPE6200 from Ricoh Company, Ltd. and Copy Paper <135> from NBS RICOH Co., Ltd. such that a toner adhered thereto in an amount of 1.0±0.1 mg/cm². A temperature of the fixing belt was changed to perform a fixing test and a maximum temperature at which the hot offset does not occur on the ordinary transfer paper was determined as a maximum fixable temperature. A temperature at which the image density of an image produced on the thick paper had a residual ratio not less than 75% was determined as a minimum fixable temperature.

(5) Conveyance of Pump

Imagio Neo 325 was modified to have a fixing belt, and a solid image was produced on an ordinary transfer paper and a thick transfer paper, i.e., TYPE6200 from Ricoh Company, Ltd. and Copy Paper <135> from NBS RICOH Co., Ltd. such that a toner adhered thereto in an amount of 1.0±0.1 mg/cm² fixable temperature was set between minimum fixable temperature and minimum fixable temperature +20° C. Number of copies and conveyance are evaluated.

In table 1, No image means abatement the test because of toner stop up of toner transport portion.

lower image density means continue the test despite of low supply because of toner stop up of toner transport portion.

As shown in example 1-9, fine powder content of Dn/2 is equal to or less than 20 pices %. Or even if a powder pump is used by making fine powder content of 0.7-2.0 μm less than 8%, and 10,000 pieces of consecutive imaging is performed, there is not outbreak in question, and there is not a problem in practical use.

With comparative example 1 and 2, fine powder content 20% of Dn/2 was exceeded, and a powder pump was used, and 10,000 pieces of consecutive imaging was performed, but there is a problem in practical use without toner becoming shorter occurs, and pictorial image appearing.

TABLE 1

| | | | | FPLA | | | | | Fixability | | | | |
|---|---|---|---|---|---|---|---|---|---|---|---|---|---|
| | | Particle | | Average of | Average of | | | | Lowest | | conveyance of Powder pump | | |
| | | diameter | | circularity A | circularity B | | | Charge | fixing | hot | After | After | After |
| | | Dv | Dn | 0.7 − Dn × | 0.7 − Dn × | Dn/2 μm or | 0.7-2.0 μm | amount | temp. | offset | 10000 | 20000 | 50000 |
| | | [μm] | [μm] | 2 μm | 2 μm | less[num %] | [num %] | [μC/g] | [° C.] | [° C.] | printed | printed | printed |
| Example 1 | Toner1 | 4.73 | 4.00 | 0.99 | 0.98 | 18.3 | 8.3 | −17.2 | 165 | 220 | ◯ | Allophone | No |
| | | | | | | | | | | | | and lower | image |
| | | | | | | | | | | | | image | |
| | | | | | | | | | | | | density | |
| Example 2 | Toner2 | 4.82 | 4.02 | 0.99 | 0.97 | 19.1 | 8.0 | −16.2 | 170 | 225 | ◯ | Allophone | No |
| | | | | | | | | | | | | | image |
| Example 3 | Toner5 | 4.65 | 3.94 | 0.98 | 0.97 | 14.6 | 3.0 | −18.3 | 155 | 240 | ◯ | ◯ | lower |
| | | | | | | | | | | and | | | image |
| | | | | | | | | | | Over | | | density |
| Example 4 | Toner6 | 4.72 | 4.10 | 0.96 | 0.95 | 12.0 | 3.7 | −23.4 | 160 | 240 | ◯ | ◯ | ◯ |
| | | | | | | | | | | and | | | |
| | | | | | | | | | | Over | | | |
| Example 5 | Toner7 | 4.69 | 4.01 | 0.96 | 0.95 | 13.5 | 3.9 | −22.9 | 160 | 240 | ◯ | ◯ | ◯ |
| | | | | | | | | | | and | | | |
| | | | | | | | | | | Over | | | |
| Example 6 | Toner8 | 4.64 | 3.96 | 0.96 | 0.94 | 12.9 | 4.1 | −24.8 | 160 | 240 | ◯ | ◯ | ◯ |
| | | | | | | | | | | and | | | |
| | | | | | | | | | | Over | | | |
| Example 7 | Toner9 | 4.67 | 3.98 | 0.95 | 0.94 | 12.2 | 4.5 | −26.6 | 160 | 240 | ◯ | ◯ | ◯ |
| | | | | | | | | | | and | | | |
| | | | | | | | | | | Over | | | |
| Comp. | Toner3 | 4.68 | 3.86 | 0.99 | 0.99 | 21.8 | 10.1 | −16.5 | 170 | 225 | No | — | — |
| Example 1 | | | | | | | | | | | image | | |

This application claims priority and contains subject matter related to Japanese Patent Application No. 2004-222460, filed on Jul. 29, 2004, the entire contents of which are incorporated herein by reference.

Having now fully described the invention, it will be apparent to one of ordinary skill in the art that many changes and modifications can be made thereto without departing from the spirit and scope of the invention as set forth herein.

1. An image forming apparatus, comprising:
a powder convey apparatus having a powder pump, a developer apparatus, an air pump, and a transfer tube,
wherein the transfer tube is connected to the air pump and the powder convey apparatus,
wherein the powder convey apparatus contains at least one of a toner and a toner and a developer,
wherein the toner has a volume average diameter Dᵥ of from 2 to 8 μm and the number of fine particles having a diameter of one-half the number average diameter Dₙ of the toner particles or less is 20% by number or less, and
wherein the toner is obtained by aqueous emulsion polymerization of a mixture comprising at least one of a colorant and a pigment; and at least one of a polymer, a mixture of monomers and a mixture comprising one or more monomers and a polymer.

2. The image forming apparatus of claim 1, wherein the powder pump comprises a rotor and a stator.

3. The image forming apparatus according to claim 1, wherein the number of fine particles having a particle size of from 0.7 to 2 μm is 8% by number or less.

4. The image forming apparatus according to claim 1, wherein the ratio Dᵥ/Dₙ is 1.25 or less.

5. The image forming apparatus according to claim 2, wherein the rotor is in contact with the toner or a mixture of the toner and a developer.

6. The image forming apparatus according to claim 1, wherein the powder pump has a member connected to the image forming apparatus.

7. The image forming apparatus according to claim 1, wherein the powder pump has a member connected to the image forming apparatus and the rotor is in contact with the toner or a mixture of the toner with a developer.

8. The image forming apparatus according to claim 1, further comprising an amorphous silicon photoconductor.

9. The image forming apparatus according to claim 1, further comprising a contact charger having a charge member in direct contact with a photoconductor.

10. The image forming apparatus according to claim 1, wherein a latent image is developable with alternating current.

11. The image forming apparatus according to claim 1, further comprising a fixing apparatus having a fixing film contacting a heating member having a heating sensor.

12. The image forming apparatus according to claim 1, further comprising a fixing apparatus having a fixing film in direct contact with a heating member having a heating sensor, and a pressure roller, wherein a substrate to which an image is fixed is present between the pressure roller and the film.

13. The image forming apparatus according to claim 1, wherein the powder convey apparatus comprises a detachable toner container.

14. The image forming apparatus according to claim 13, wherein the toner container comprises the powder pump.

15. The image forming apparatus according to claim 13, wherein the toner container is a flexible.

16. The image forming apparatus of claim 1, wherein the toner particles adhere to the following formula:
1.0≦(1−B)/(1−A)≦4.0
wherein A is the average circular rate of particles having a number average diameter of from 0.7 to (Dₙ)/2 μm and B is the average circular rate of particles having a number average diameter (Dₙ) of from 0.7 μm to (Dₙ×2)μm.

17. The image forming apparatus according to claim 1, wherein the toner comprises one or more fine particles having an average particle diameter of 30 to 300 nm present on the surface of the toner particle.

18. The image forming apparatus according to claim 1, wherein the toner has an average particle diameter of 30 to 300 nm.

19. The image forming apparatus according to claim 1, wherein the toner comprises one or more inorganic particles present on the surface of the toner particle.

20. The image forming apparatus according to claim 1, where at least one of a plurality of inorganic particles, a plurality of organic particles and a plurality of both inorganic and organic particles are present on the surface of the toner particles.

21. The image forming apparatus according to claim 1, wherein the toner particles comprise a plurality of inorganic particles present on the surface of the toner particles.

22. The image forming apparatus according to claim 1, wherein the toner particles comprise an active hydrogen, a colorant, a releasing agent, and a hydrophobic inorganic particle, wherein the toner is obtained by dispersing a solution containing at least one of a monomer mixture and a polymer, and a colorant, in an organic solvent dispersed in water, and wherein the polymerized mixture contains an active hydrogen.

23. The image forming apparatus according to claim 1, wherein the toner is obtained by a process comprising:
preparing a dispersion in an organic solvent of a compound having an active hydrogen group, a polymer, a colorant, a release agent and a hydrophobicized inorganic particle; then
dispersing the dispersion in water to form an aqueous dispersion;
reacting the aqueous dispersion;
removing the organic solvent during the reacting or after the reacting to form a residue;
washing the reside to form a wet toner; and
drying the wet toner to form the toner.

24. The image forming apparatus according to claim 1, wherein the toner particles having a diameter of from 0.7 μm to Dₙ/2 μm have an average circular rate of from 0.94 to 0.995 measured by a flow-type granularity image analyzer.

25. An image forming apparatus, comprising:
a powder convey apparatus having a powder pump, a developer apparatus, an air pump, and a transfer tube,
wherein the transfer tube is connected to the air pump and the powder convey apparatus,
wherein the powder convey apparatus contains at least one of a toner and a toner and a developer,
wherein the toner has a volume average diameter Dᵥ of from 3 to 7 μm and the number of fine particles having a number average diameter Dₙ of from 0.7 to 2 μm is 8% or less by number, and
wherein the toner is obtained by aqueous emulsion polymerization of a mixture comprising at least one of a colorant and a pigment; and at least one of a polymer, a mixture of monomers and a mixture comprising one or more monomers and a polymer.

26-48. (canceled)

49. A toner manufactured by polymerizing an aqueous dispersion of a mixture comprising at least one pigment, and at least one of a polymer and a mixture of monomers,
wherein the toner particles has a volume average diameter Dᵥ of from 2 to 8 μm,
and the amount of fine particles having a diameter of one-half the average number diameter Dₙ or less is 20% by number or less.

50. The toner according to claim 49, wherein the number of fine particles having a particle size of from 0.7 to 2 μm is 8% by number or less.

51. The toner according to claim 49, wherein the ratio Dᵥ/Dₙ is 1.25 or less.

52. The toner of claim 49, wherein the toner particles adhere to the following formula:
1.0≦(1−B)/(1−A)≦4.0
wherein A is the average circular rate of particles having a number average diameter of from 0.7 to (Dₙ)/2 μm and B is the average circular rate of particles having a number average diameter Dₙ of from 0.7 μm to (Dₙ×2)μm.

53. The toner according to claim 49, wherein the toner comprises one or more fine particles having an average particle diameter of 30 to 300 nm present on the surface of the toner particle.

54. The toner according to claim 49, wherein the toner has an average particle diameter of 30 to 300 nm.

55. The toner according to claim 49, wherein the toner comprises one or more inorganic particles present on the surface of the toner particle.

56. The toner according to claim 49, where at least one of a plurality of inorganic particles, a plurality of organic particles and a plurality of both inorganic and organic particles are present on the surface of the toner particles.

57. The toner according to claim 49, wherein the toner particles comprise a plurality of inorganic particles present on the surface of the toner particles.

58. The toner according to claim 49, wherein the toner particles comprise an active hydrogen, a colorant, a releasing agent, and a hydrophobic inorganic particle, wherein the toner is obtained by dispersing a solution containing at least one of a monomer mixture and a polymer, and a colorant, in an organic solvent dispersed in water, and wherein the polymerized mixture contains an active hydrogen.

59. The toner according to claim 49, wherein the toner is obtained by a process comprising:
preparing a dispersion in an organic solvent of a compound having an active hydrogen group, a polymer, a colorant, a release agent and a hydrophobicized inorganic particle; then
dispersing the dispersion in water to form an aqueous dispersion;
reacting the aqueous dispersion;
removing the organic solvent during the reacting or after the reacting to form a residue;
washing the reside to form a wet toner; and
drying the wet toner to form the toner.

60. The toner according to claim 49, wherein the toner particles having a diameter of from 0.7 μm to Dₙ/2 μm have an average circular rate of from 0.94 to 0.995 measured by a flow-type granularity image analyzer.

61. A toner manufactured by polymerizing an aqueous dispersion of a mixture comprising at least one pigment, and at least one of a polymer and a mixture of monomers,
wherein the toner particles has a volume average diameter Dᵥ of from 3 to 7 μm,
and the amount of fine particles having a number average diameter from 0.7 to 2 μm is 8% by number or less.

62-72. (canceled)

73. A method for electrophotographic reproduction, comprising:
developing a latent image with a toner or a mixture of a toner and a developer,
wherein the toner is transferred from a toner container to a developer apparatus through a transfer tube by a flow of air,
wherein the method is carried out with the apparatus of claim 1.

74. The method of claim 73, wherein the toner container is detachable and comprises a powder pump.

75. A method for electrophotographic reproduction, comprising:
developing a latent image with a toner or a mixture of a toner and a developer,
wherein the toner is transferred from a toner container to a developer apparatus through a transfer tube by a flow of air,
wherein the method is carried out with the apparatus of claim 25.

76. (canceled)

77. A toner container, comprising:
a toner or a toner and a developer, and a powder pump,
wherein the toner is prepared by polymerizing an aqueous dispersion of at least one pigment and at least one of a polymer, a mixture of monomers and a mixture of a polymer and a mixture of monomers,
wherein the amount of fine particles present in the toner having an average number diameter of Dₘ/2 or less is 20% by number and the toner has an Dᵥ of from 2 to 8 μm.

78. The toner container of claim 77, wherein the container is flexible.

79. The toner container of claim 77, wherein the powder pump comprises a rotor and a stator.

80. The toner container of claim 77, wherein the number of fine particles having a particle size of from 0.7 to 2 μm is 8% by number or less in the toner.

81. The toner container of claim 77, wherein the toner particles of the toner have a ratio Dᵥ/Dₙ is 1.25 or less.

82. The toner container of claim 79, wherein the rotor is in contact with the toner or a mixture of the toner and a developer.

83. The toner container of claim 77, wherein the powder pump has a member connected to the image forming apparatus.

84. The toner container of claim 77, wherein the powder pump has a member connected to the image forming apparatus and the rotor is in contact with the toner or a mixture of the toner with a developer.

85. The toner container of claim 77, wherein the toner particles adhere to the following formula:
1.0≦(1−B)/(1−A)≦4.0
wherein A is the average circular rate of particles having a number average diameter of from 0.7 to (Dₙ)/2 μm and B is the average circular rate of particles having a number average diameter (Dₙ) of from 0.7 μm to (Dₙ×2)μm.

86. The toner container of claim 77, wherein the toner comprises one or more fine particles having an average particle diameter of 30 to 300 nm present on the surface of the toner particle.

87. The toner container of claim 77, wherein the toner has an average particle diameter of 30 to 300 nm.

88. The toner container of claim 77, wherein the toner comprises one or more inorganic particles present on the surface of the toner particle.

89. The toner container of claim 77, where at least one of a plurality of inorganic particles, a plurality of organic particles and a plurality of both inorganic and organic particles are present on the surface of the toner particles.

90. The toner container of claim 77, wherein the toner particles comprise a plurality of inorganic particles present on the surface of the toner particles.

91. The toner container of claim 77, wherein the toner particles comprise an active hydrogen, a colorant, a releasing agent, and a hydrophobic inorganic particle, wherein the toner is obtained by dispersing a solution containing at least one of a monomer mixture and a polymer, and a colorant, in an organic solvent dispersed in water, and wherein the polymerized mixture contains an active hydrogen.

92. The toner container of claim 77, wherein the toner is obtained by a process comprising:
preparing a dispersion in an organic solvent of a compound having an active hydrogen group, a polymer, a colorant, a release agent and a hydrophobicized inorganic particle; then
dispersing the dispersion in water to form an aqueous dispersion;
reacting the aqueous dispersion;
removing the organic solvent during the reacting or after the reacting to form a residue;
washing the reside to form a wet toner; and
drying the wet toner to form the toner.

93. The toner container of claim 77, wherein the toner particles having a diameter of from 0.7 μm to Dₙ/2 μm have an average circular rate of from 0.94 to 0.995 measured by a flow-type granularity image analyzer.

94. A toner container, comprising:
a toner or a toner and a developer, and a powder pump,
wherein the toner is prepared by polymerizing an aqueous dispersion of at least one pigment and at least one of a polymer, a mixture of monomers and a mixture of a polymer and a mixture of monomers,
wherein the toner particles have a volume average diameter Dᵥ of from 3 to 7 μm and the number of particles having a number average diameter of from 0.7 to 2 μm is 8% by number or less.

95-110. (canceled)
